(19) United States
(12) Patent Application Publication
(10) Pub. No.: US 2026/0181386 A1
(43) Pub. Date: Jun. 25, 2026

(54) LINK-LAYER ADDRESS CONCEALMENT FOR TRANSMISSION SECURITY (TRANSEC) ENABLED TERMINALS IN SATELLITE COMMUNICATION NETWORKS

(71) Applicant: Hughes Network Systems, LLC, Germantown, MD (US)

(72) Inventor: John Border, Middletown, MD (US)

(21) Appl. No.: 18/988,055

(22) Filed: Dec. 19, 2024

(51) Int. Cl. H04W 12/037; H04W 72/0453; H04W 84/06

(52) U.S. Cl. CPC H04W 12/037; H04W 72/0453; H04W 84/06

(57) ABSTRACT

Approaches are described herein for link-layer address concealment for transmission security (TRANSEC) enabled (TE) terminals in satellite communication networks. For example, TE terminals can randomly select a proposed masked system assigned identifier (mSAI), which is a temporary identifier different from any real identifiers of the terminal (e.g., a real SAI, real electronic serial number, etc.). The ground station (e.g., inroute group manager) checks availability of the mSAI. If available, the request is acknowledged, the mSAI is assigned to the terminal, and bandwidth is allocated to the terminal using the mSAI. Subsequent allocated bursts can be sent by the terminal using the allocated bandwidth based on the mSAI. Some embodiments include techniques for handling requests for an unavailable mSAI, simultaneous requests by different terminals for the same mSAI, periodic changes of mSAIs for added security, and use of mSAI-related timers to support additional features.

### BACKGROUND

In satellite communication networks, satellites communicate with ground stations. At least because the satellites have predictable orbits, constant emission of signals, and transmissions with wide geographic footprints, their communications present significant challenges in terms of communication security. Transmission Security (TRANSEC), in context of satellite communication systems, generally describes technologies that seek to safeguard the integrity and confidentiality of signals transmitted between satellites and ground stations, such as by preventing adversaries from intercepting, jamming, or exploiting satellite signals for intelligence purposes, even when the content is encrypted.

Some TRANSEC technologies, such as frequency hopping, spread spectrum modulation, and signal encryption, are designed to obscure physical characteristics of the transmission. Other TRANSEC technologies control electromagnetic emissions and the timing of signal transmissions. For example, an adversary could potentially track satellite positions and infer communication patterns, even if they cannot access the actual content of the communication, but TRANSEC protocols can minimize the detectable electromagnetic signature through power control and low-probability-of-intercept (LPI) techniques to reduce the chance of detection by enemy surveillance systems. Additionally, satellite communications often employ encryption at the transmission level to protect metadata, such as the time and duration of communications, which can provide critical information about operational patterns. These and/or other TRANSEC technologies can appreciably enhance the security and resilience of their communication networks in contested environments.

### BRIEF SUMMARY

Systems and methods are described herein for link-layer address concealment for transmission security (TRANSEC) enabled (TE) terminals in satellite communication networks. For example, TE terminals can randomly select a proposed masked system assigned identifier (mSAI), which is a temporary identifier different from any real identifiers of the terminal (e.g., a real SAI, real electronic serial number, etc.). The ground station (e.g., inroute group manager) checks availability of the mSAI. If available, the request is acknowledged, the mSAI is assigned to the terminal, and bandwidth is allocated to the terminal using the mSAI. Subsequent allocated bursts can be sent by the terminal using the allocated bandwidth based on the mSAI. Some embodiments include techniques for handling requests for an unavailable mSAI, simultaneous requests by different terminals for the same mSAI, periodic changes of mSAIs for added security, and use of mSAI-related timers to support additional features.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an example of a hybrid satellite communication system (i.e., having both TRANSEC-enabled and non-TRANSEC-enabled terminals), as a context for embodiments described herein.

FIG. 2 shows another example of a hybrid satellite communication system, including block diagrams of an illustrative TRANSEC-enabled terminal, an illustrative non-TRANSEC-enabled terminal, and an illustrative unified ground station.

FIG. 3 shows a ladder diagram for an illustrative secure terminal registration procedure, according to embodiments described herein.

FIG. 4 shows a flow diagram of an illustrative method for initial configuration of a TRANSEC-enabled terminal, according to embodiments described herein.

FIG. 5 shows a flow diagram of an illustrative method for initializing a TRANSEC-enabled terminal for secure communications in a satellite communication network, according to embodiments described herein.

FIGS. 6A and 6B provide schematic illustrations of embodiments of computational systems that can implement various system components and/or perform various steps of methods provided by various embodiments.

FIG. 7 shows a traffic flow diagram for outroute traffic through a link-layer security path without TRANSEC.

FIG. 8 shows an illustrative packet format for an encrypted stream encapsulated (SE) packet without TRANSEC.

FIG. 9 shows a traffic flow diagram for inroute traffic through a link-layer security path without TRANSEC.

FIGS. 10A and 10B show two illustrative packet formats for an encrypted burst without TRANSEC.

FIG. 11 shows an example outroute packet flow through a link-layer security path with TRANSEC encryption, according to embodiments herein.

FIG. 12 shows an illustrative SE-T packet format for an encapsulated PDU, according to some embodiments.

FIG. 13 shows an illustrative fragmented SE-T packet format for an encapsulated PDU, according to some embodiments.

FIG. 14 shows a flow diagram of an illustrative method for implementing outroute link-layer transmission security (TRANSEC) in a transmit-side of a satellite communication system, according to some embodiments described herein.

FIG. 15 shows a flow diagram of an illustrative method for implementing outroute link-layer transmission security (TRANSEC) in a receiving side of a satellite communication system, according to some embodiments described herein.

FIGS. 16A and 16B show two illustrative packet formats for an encrypted burst with TRANSEC, encapsulated according to the IBE-T protocol.

FIG. 17 shows an illustrative representation of three potential states of a masked system assigned identifier (mSAI) for a terminal, according to some embodiments.

FIG. 18 shows an example data flow for creating a TE terminal identifier hash, according to some embodiments.

FIG. 19 shows an illustrative flow diagram of a method performed at a terminal side when a TE terminal is going active while operating with TRANSEC enabled, according to some embodiments described herein.

FIG. 20 shows an illustrative flow diagram of a method performed at an inroute group manager (IGM) side, corresponding to the terminal-side method of FIG. 19, according to some embodiments described herein.

FIG. 21 shows a ladder diagram representing a TE terminal successfully going active with a new mSAI on a first attempt.

FIG. 22 shows a ladder diagram representing a TE terminal first unsuccessfully going active due to a mSAI collision and subsequently successfully going active after selecting a different non-colliding mSAI.

FIG. 23 shows a ladder diagram representing two TE terminals attempting to go active at the same time using the same randomly selected masked SAI value.

FIG. 24 shows an illustrative flow diagram of a method performed at a terminal side when a TE terminal is changing its mSAI while active, according to some embodiments described herein.

FIG. 25 shows an illustrative flow diagram of a method performed at an inroute group manager (IGM) side, corresponding to the terminal-side method of FIG. 24, according to some embodiments described herein.

FIG. 26 shows a ladder diagram representing a TE terminal successfully changing its mSAI while active on a first attempt.

FIG. 27 shows a ladder diagram representing a TE terminal first unsuccessfully changing its mSAI due to a collision, and then successfully changing its mSAI on a second attempt.

### DETAILED DESCRIPTION

In the following description, for the purposes of explanation, various specific details are set forth to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

TRANSEC (Transmission Security) prevents an adversary from exploiting information available in a communication channel without necessarily having defeated encryption. TRANSEC can require all network control channels and Management & Control (M&C) data to be encrypted and that any and all traffic engineering information be obfuscated from an adversary. For example, TRANSEC requires a communication channel to appear completely full to an adversary, even if little or no actual data is flowing. This is contrasted with communications security (COMSEC), where actual information is encrypted, but certain header information is sent in the clear. From these, an adversary can determine how much of the traffic streams is voice, video, or data.

TRANSEC is not a new area of technology. For example, some TRANSEC concepts are outlined by the National Security Agency (NSA). However, embodiments described herein provide novel TRANSEC technologies in context of satellite communication networks, including technologies for addressing several deficiencies of conventional TRANSEC concepts.

One such deficiency relates to securely registering TRANSEC-enabled terminals. This can include securely implementing installation, commissioning, and/or other registration-related features. For example, conventional approaches are unable to provide secure communications with terminals prior to completion of a terminal's registration. Embodiments described herein include techniques for securing communications with TRANSEC-enabled terminals even prior to registration.

Another such deficiency relates to control and management channel security. Embodiments provide smart protocols designed to support control and management plane security by encryption, masking, and/or obfuscation. Some embodiments provide techniques to address other deficiencies, which relate to secure terminal installation and registration support.

Another such deficiency relates to masking channel activity. In a Single Channel Per Carrier (SCPC) satellite communication network, each communication channel is assigned a specific frequency and bandwidth. In such networks, the link is static with no variation in transmission characteristics based on end user communication. An adversary looking at a satellite transponder with a spectrum analyzer can see a constant radiofrequency (RF) signal. For example, this can be contrasted with time division multiple access (TDMA) and frequency division multiple access (FDMA) networks. Embodiments include approaches to tackle masking channel activity in such network environments, which can be technologically complex.

Another such deficiency relates to obfuscating acquisition activity. In TDMA networks, dedicated unallocated bursts are configured for acquisition of inroute by requesting stream bursts, timing, and power adjustments. The rate at which remotes acquire into a network can provide critical information to an adversary about troop activities. TDMA networks provide a dedicated channel for remote acquisition activity. If adversaries monitor the activity in this channel, they can be alerted to troop movements by a flurry of acquisition activity. Embodiments include approaches to address these concerns.

Embodiments described herein provide effective TRANSEC in satellite communication networks that have a hybrid of TRANSEC-enabled (TE) and non-TRANSEC-enabled (NTE) terminals, without adding system overhead in terms of satellite bandwidth usage. Embodiments described herein can operate in a variety of satellite communication network contexts. For example, embodiments can be implemented in context of both geosynchronous orbit (GEO) and non-geosynchronous orbit (NGSO) satellites, such as low Earth orbit (LEO) and medium Earth orbit (MEO) satellites. Embodiments can also be implemented with satellites having different capacities, such as high throughput satellites (HTS), very high throughput satellites (VHTS), etc. Embodiments can also be implemented with different satellite capabilities, such as regenerative satellites of a LEO constellation having flexible channelizers.

### I. Hybrid TRANSEC/Non-TRANSEC Satellite Communication Systems

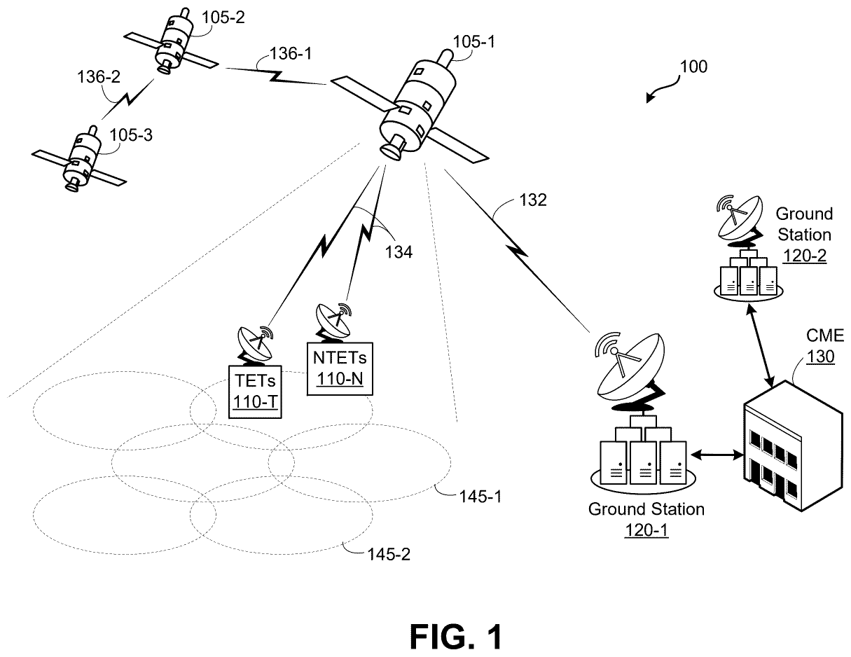

FIG. 1 shows an example of a hybrid satellite communication system 100 (i.e., having both TRANSEC-enabled and non-TRANSEC-enabled terminals), as a context for embodiments described herein. As illustrated, the satellite communication system 100 includes one or more ground stations 120 in communication with a large number of geographically diverse user terminals (UTs) 110 via one or more satellites 105. The illustrated communication system 100 includes a constellation of satellites 105. The UTs 110 are located in cells 145. The ground stations 120 can be in communication with a central management entity (CME) 130 via a terrestrial infrastructure.

The satellites 105 can include any suitable type of communication satellite. In some implementations, some or all of the satellites 105 are geostationary Earth orbit (GEO) satellites. Such GEO satellites are generally positioned in a geosynchronous orbit approximately 35,786 kilometers above the equator, so as to remain fixed relative to a point on the surface of the Earth. In other implementations, some or all of the satellites 105 are non-geosynchronous orbit (NGSO) satellites, such as medium Earth orbit (MEO) satellites that typically orbit the Earth at altitudes between around 2,000 and 35,786 kilometers, and/or low Earth orbit (LEO) satellites that typically orbit the Earth at altitudes ranging from about 160 to 2,000 kilometers. In some implementations, some or all of the satellites 105 can have large chassis. For example, a satellite 105 can have a chassis approximately the size of a bus. In other implementations, some or all of the satellites 105 can have small chassis. For example, so-called “smallsats” can include femtosatellites typically weighing less than 100 grams, picosatellites typically weighing between 100 grams and 1 kilogram, nanosatellites typically weighing between 1 and 10 kilograms, microsatellites typically weighing between 10 and 100 kilograms, and minisatellites typically weighing between 100 and 500 kilograms. As one common example, so-called “CubeSats” are a type of nanosatellite with a standard CubeSat unit (1U) defined as a 10 cm cube with a mass up to 1.33 kilograms.

The communication system 100 includes a large number of user terminals 110. One or more (or all) of the user terminals 110 can be implemented as Very Small Aperture Terminals (VSATs). VSATs are small satellite dishes that can be used for a variety of applications, including internet access, data communication, and voice over IP (VoIP) services. VSATs can be mobile or fixed terminals. Additionally or alternatively, the user terminals 110 can be implemented as or in desktop computers, laptops, smartphones, tablets, industrial control devices, Internet of Things (IoT) devices, specialized communication equipment, etc.

As illustrated, the satellites 105 communicate with user terminals 110 via one or more user links 134 and with ground-based infrastructures (e.g., ground stations 120) via one or more feeder links 132. Forward-link communications can be sent from a ground station 120 up to a satellite 105 via an uplink portion of a feeder link 132 (i.e., a “feeder uplink,” a “forward uplink,” etc.) and from the satellite 105 down to one or more user terminal 110 via a downlink portion of one or more user links 134 (i.e., a “user downlink,” a “forward downlink,” etc.). Return-link communications can be sent from a user terminal 110 up to a satellite 105 via an uplink portion of a user link 134 (i.e., a “user uplink,” a “return uplink,” etc.) and from the satellite 105 down to a ground station 120 via a downlink portion of a feeder link 134 (i.e., a “feeder downlink,” a “return downlink,” etc.).

In implementations having a constellation of satellites 105, the satellite constellation can include several (e.g., tens of) satellites 105, hundreds or even thousands of satellites 105, etc. Some or all of the satellites 105 can communicate with adjacent satellites in their constellation via inter-satellite links (ISLs) 136. ISLs 136 allow direct communication between satellites without relaying data back to the Earth, which can enhance the reliability, robustness, and speed of communications. In some implementations, the ISLs 136 facilitate communication between adjacent satellites 105 sharing a same orbital plane. In other implementations, the ISLs 136 facilitate communication between satellites 105 in adjacent orbital planes.

As illustrated, the communication system 100 can include a centralized management entity (CME) 130. The CME 130 can be implemented as one or more entities in one or more locations to provide features associated with orchestration and optimization of network operations, including scheduling, resource allocation, traffic management, and overall network coordination. In some implementations, the CME 130 is located at one or more central ground stations. In other implementations, the CME 130 is located at an operations center, such as a network operations center (NOC), a satellite operations center (SOC), global network operations center (GNOC), etc. In such locations, the CME 130 has access to robust computational resources and high-bandwidth terrestrial connectivity by which to effectively monitor and control the entire satellite network infrastructure. The CME 130 can communicate with ground stations 120 through high-speed terrestrial links and/or dedicated satellite communication channels.

As illustrated, some of the user terminals 110 are TRANSEC-enabled (TE) terminals (TET) 110-T, and others of the user terminals 110 are non-TRANSEC-enabled terminals (NTET) 110-N. As used herein, each TET 110-T is designed to ensure the security and integrity of data transmitted over satellite links. The TETs 110-T are equipped with specialized modules that implement TRANSEC measures, which can include encryption, frequency hopping, and other advanced techniques to protect data from interception, jamming, and unauthorized access. Conversely, as used herein, each NTET 110-N is a user terminal 110 that does not incorporate TRANSEC measures. These terminals are designed to handle standard satellite communication tasks without the added layer of transmission security provided by encryption and other TRANSEC techniques. Some embodiments described herein facilitate use of novel TET 110-T communications along with conventional NTET 110-N communications in a same network, so that novel techniques described herein are compatible augmentations to existing NTET 110-N infrastructures.

The communication system 100 includes one or more ground stations 120. As used herein, a ground station 120 generally refers to a primary interface between terrestrial networks and satellites at the feeder side of the network. Ground stations 120 typically include at least an antenna system for transmitting and receiving signals to and from the satellite and a modem/router to process the signals. The processing can include modulation and demodulation, error correction, encryption/decryption, protocol management, etc. In some cases, the ground stations 120 can include higher level functions, such as a network management system (NMS) to continuously monitor and manage network performance (e.g., fault detection, performance analysis, configuration management, etc.) and/or a control center to coordinate with the NMS to ensure optimal network functionality and to manage data traffic flow. In some implementations, NMS, control center, and/or other functions are handled by the CME 130, or in conjunction with the CME 130.

As described herein, TRANSEC communications involve security both at the user terminal 110 (TET 110-T) side and at the ground station 120 side of the network. Although not explicitly shown, some embodiments of the communication system 100 include separate TE ground stations 120 and non-TE ground stations 120. In such embodiments, TETs 110-T are in communication with TE ground stations 120, and NTETs 110-N are in communication with non-TE ground stations 120. For example, all data passing through a TE ground station 120 is secure and adheres to TRANSEC protocols. Such embodiments can provide certain features, such as providing clear separation of secure and non-secure communications to simplify security management and reduce the risk of accidental data breaches, and/or simplifying processing of non-TE communications without additional overhead concerns. However, such embodiments can also be more complex (e.g., maintaining and managing separate ground stations can increase the complexity of the network infrastructure), more expensive (e.g., additional hardware and management resources may be involved in supporting separate ground stations), etc. Further, such embodiments can reduce network efficiencies, such as relating to data routing, load balancing, failure handling, etc., by restricting user terminals 110 to communicate only with portions of otherwise available ground stations 120 (e.g., TETs 110-T can only use resources of TE ground stations 120).

Other embodiments use unified ground stations 120 that support both TE and non-TE communications. In such embodiments, all ground stations 120 have integrated TRANSEC capabilities but can handle non-TRANSEC data, as well. For example, such unified ground stations 120 can apply encryption/decryption as needed for TE data while allowing non-TE data to pass through without encryption. Such embodiments can result in each ground station 120 being more complex. However, such embodiments can simplify network design and management and can increase flexibility and adaptability by allowing all ground stations 120 to dynamically handle both secure and non-secure communications.

Embodiments are generally described herein assuming an architecture in which at least some of the ground stations 120 are unified ground stations. For example, all ground stations 120 may be unified ground stations 120, some ground stations 120 are unified ground stations 120 and the rest are non-TE ground stations 120, or some ground stations 120 are unified ground stations 120 and the rest are a combination of TE and non-TE ground stations 120. References herein to ground stations 120 generally assume a unified ground station 120, unless noted otherwise.

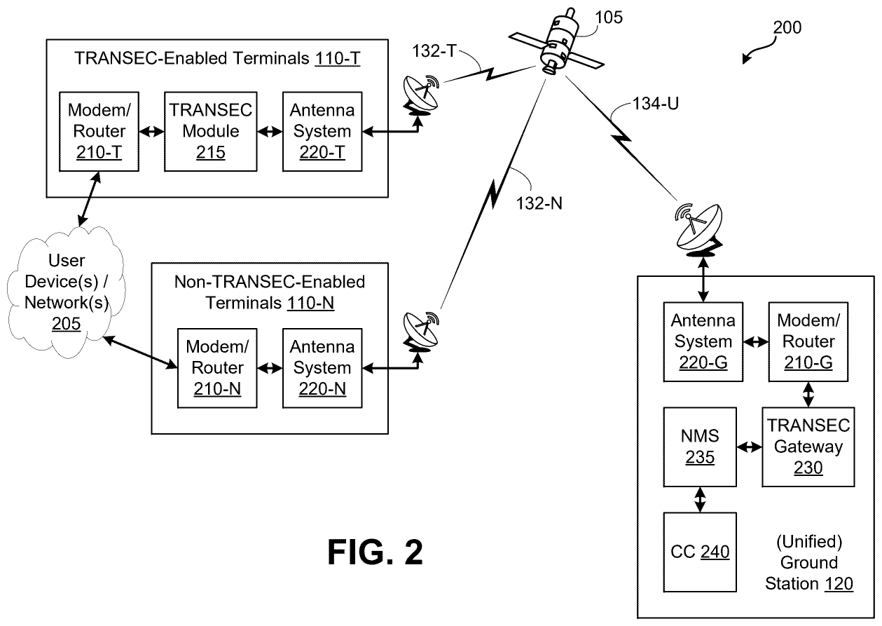

FIG. 2 shows another example of a hybrid satellite communication system 200, including block diagrams of an illustrative TET 110-T, an illustrative NTET 110-N, and an illustrative unified ground station 120. The satellite communication system 200 is designed to facilitate secure and non-secure communication across various user terminals 110 through one or more satellites 105 (only one is shown). The system includes TRANSEC-enabled terminals (TETs 110-T) and non-TRANSEC-enabled terminals (NTETs 110-N), each having distinct components tailored to their security needs.

Each TET 110-T includes at least a modem/router 210-T, a TRANSEC module 215, and an antenna system 220-T. The modem/router 210-T handles standard communication protocols, data formatting, and network management tasks. The TRANSEC module 215 is positioned between the modem/router 210-T and the antenna system 220-T, ensuring that outgoing data is encrypted and incoming data is decrypted, providing end-to-end security. The antenna system 220-T is responsible for sending and receiving encrypted signals to and from the satellite 105.

Each NTET 110-N includes at least a modem/router 210-N and an antenna system 220-N (i.e., the NTETs 110-N do not include TRANSEC modules 215). The modem/router 210-N manages data formatting, protocol conversion, and network routing without the additional security layer provided by a TRANSEC module. The antenna system 220-N transmits and receives unencrypted signals to and from the satellite.

Both TETs 110-T and NTETs 110-N connect to user device(s) and/or network(s) 205. For example, on the hardware side, the user device(s)/network(s) 205 can include computers, workstations, mobile devices, peripheral devices, networking equipment, file servers, application servers, database servers, storage devices, cloud storage solutions, sensors, Internet-of-things (IoT) devices, VoIP phones, antennas, satellite dishes, modems, transceivers, firewalls, security appliances, power supply units, etc. On the software side, user device(s)/network(s) 205 can include operating systems, communication software, network management software tools, security software, data management software, productivity software, virtualization software, collaboration tools, etc. On the network side, user device(s)/network(s) 205 can include any suitable user networks, such as local area networks (LANs), wide area networks (WANs), metropolitan area networks (MANs), virtual private networks (VPNs), enterprise networks, industrial control networks, IoT networks, mobile networks, hybrid networks, cloud networks, etc. User device(s)/network(s) 205 can also include connectivity and/or integration components (e.g., APIs and middleware), virtual private networks and/or remote access solutions, cloud services, user interface components and/or user portals, etc. In some implementations, user device(s)/network(s) 205 can include support and/or maintenance components, remote management tools, etc.

The ground station 120 (illustrated as a universal ground station 120) includes a modem/router 210-G, an antenna system 220-G, a TRANSEC gateway 230, a network management system (NMS) 235, and a control center (CC) 240. The modem/router 210-G interfaces with both TETs 110-T and NTETs 110-N, handling data formatting and routing for secure and non-secure communications. The antenna system 220-G transmits and receives signals to and from the satellite 105. The TRANSEC gateway 230 is responsible for encrypting and decrypting data (i.e., to ensure secure communications with TETs 110-T).

As noted above, some implementations of ground stations 120 can include an NMS 235 and/or a CC 240. The NMS 235 monitors and manages the satellite network, providing real-time performance analysis, fault detection, and configuration management. The Control Center 240 oversees the overall network operations, coordinating with the NMS 235 to manage data traffic flow and ensure efficient operation of the satellite communication system 200. The ground station 120 can include additional components, such as for interfacing with a terrestrial backhaul network, for interfacing with a CME 130, etc.

In the return direction, TETs 110-T communicate management plane data with the satellite 105 via TE user links 132-T (i.e., secure). The NTETs 110-N communicate with the satellite 105 via a via non-TE user links 132-N (insecure). Those signals are received by the ground station 120 from the satellite 105 via feeder links 134-U (carrying secure and insecure communications). Upon reaching the ground station 120, the signals are first received by the antenna system 220-G, which is responsible for capturing and directing the signals to the appropriate processing units. The received signals are then passed to the modem/router 210-G, which handles the initial signal processing, such as demodulation and protocol conversion. For secure communications, the data is then routed to the TRANSEC gateway 230, where encrypted data from TETs 110-T is decrypted. The decrypted data, along with the unencrypted data from NTETs 110-N, is forwarded to the NMS 235, which monitors and manages the data, ensuring optimal network performance and addressing any faults or issues. The NMS 235 can forward the processed data to the CC 240, which oversees the overall network operations and coordinates the flow of data to other portions of the ground network.

In the forward direction, the management plane data data originates from the ground network (e.g., from content sources, the Internet, backhaul networks, other ground terminals 120, the CME 130, etc.) and is sent to the CC 240 at the ground station 120. The CC 240 can manage and organize the data and can pass the data to the NMS 235. For secure communications, the data is routed to the TRANSEC gateway 230, where it is encrypted. Both encrypted data for TETs 110-T and unencrypted data for NTETs 110-N are then processed by the modem/router 210-G, which formats the data for satellite transmission. The formatted signals are transmitted to the antenna system 220-G, which then sends the signals to the satellite 105 via feeder links 134-U. The satellite 105 relays the secure data to TETs 110-T via TE user links 132-T and the insecure data to NTETs 110-N via non-TE user links 132-N.

### II. Secure Registration of TRANSEC-Enabled Terminals

In general, a TRANSEC-enabled network can have only TETs 110-T or a mix of TETs 110-T and NTETs 110-N. Some embodiments described herein support a hybrid network of both TETs 110-T and NTETs 110-N without increasing system overhead in terms of satellite bandwidth usage.

Typically, a TET 110-T is created specially at a secure factory location. A group of secret information is included in the terminal factory image to designate whether the user terminal 110 terminal a is TET 110-T or not (an NTET 110-N). Only the terminal software can read and interpret this secret information. Each TET 110-T is uniquely associated with a Terminal Master Key (TMK) and an Electronic Serial Number (ESN) of its internal circuitry (e.g., its application-specific integrated circuit, ASIC). A trusted agent (TA) burns the TMK and the ESN in a secure memory location which only software of the specific TET 110-T can retrieve.

An Effective Master Key (EMK) is generated for a specific TET 110-T, and the EMK is loaded into the NMSs 235 of ground stations 120. This is used for a terminal authentication procedure and for generation of encrypted traffic link-layer session keys. The link-layer session keys are derived from a Root Session Key (RSK) and are encrypted by the EMK before being distributed securely to TETs 110-T. Concurrently, the EMK is also encrypted by the TMK to generate an Encrypted Effective Master Key (EEMK), which is then distributed over the air to the TET 110-T. The link-layer session keys are used to encrypt over-the-air unicast user and control traffic. A TET 110-T first decrypts the EEMK using the TMK to get its EMK, which it can then use to decrypt the link-layer session keys. The decrypted link-layer sessions keys can then be used to encrypt and decrypt traffic over the air.

Embodiments described herein include novel techniques for securely registering TETs 110-T in a network. Embodiments begin by calling an application programming interface (API) into the user terminal 110 in a secure physical location and by a trusted agent (TA). In some implementations, the API is part of the same API used to burn the TMK, ESN, and media access control (MAC) address. In other implementations, the API is a dedicated API. The API includes an argument to indicate whether a user terminal 110 is a TET 110-T. In some embodiments, after creating a TET 110-T, the TA deletes the copy of the TMK, thereby preventing converting a returned NTET 110-N terminal to a TET 110-T at the factory for security reasons.

If the user terminal 110 is a TET 110-T, a signed TE file is created. This is not visible as a file in the flash file system; rather it is burned into the factory image and is secret to others. In some implementations, the signed TE file is burned into the factory image as part of establishing the user terminal's 110 in-system programmable device identifier (ISPDID). The user terminal 110 includes embedded systems and/or programmable hardware, such as one or more application-specific integrated circuits (ASICs) and/or field-programmable gate arrays (FPGAs). In this context, the ISPDID is a specific configuration image programmed into an ASIC, FPGA, or the like, which provides a baseline configuration pre-installed on the user terminal 110 at the factory. The image typically includes essential firmware, software drivers, initial settings, and security features. In implementations herein, the ISPDID can include the signed TE file.

A well-known string is signed by generating a 256-bit key called the signature master key (SMK). The SMK is encrypted by the TMK to produce the encrypted signature master key (ESMK). A well-known clear string (KS) is encrypted by the SMK, resulting in the encrypted well-known string (EKS). In some embodiments, effective master keys (EMKs) are created by the TA using a predetermined algorithm and method. The same algorithm and method that are used by the TA to create EMKs can be used to create SMKs. However, the TA does not create the SMKs; rather the SMKs are created in the factory. The secret information in the factory image contains the ESMK and the EKS, not in clear.

On every boot, a user terminal 110 inspects its internal information to determine whether the signed TE file is present. If a user terminal 110 does not find the signed TE file at all, it acts as a NTET 110-N. If the signed TE file is present, the user terminal 110 performs a reverse process. It first decrypts the ESMK using the TMK to get the SMK. Then, it decrypts the EKS by the SMK to get the KS. If the decryption successfully produces the KS (which is a well-known string, by definition), the user terminal 110 internally identifies itself as a TET 110-T. If the signed TE file is present in the user terminal 110, but the KS could not be recovered, the user terminal 110 shuts down its transmit/receive (Tx/Rx) path and does not process any system information after the demodulation lock. The user terminal 110 also displays an appropriate state code in the local user interface (LUI), which indicates this user terminal 110 should not operate anymore.

Notably, if someone copies the signed TE file to another user terminal 110, the check will fail. Thus, the KS will not be successfully recovered, and the state code will be displayed in the LUI. This is because the SMK, stored as the ESMK, can only be decrypted by the TMK, which is highly secure. The correct SMK cannot be obtained by another user terminal 110 that has a different TMK.

Once a TET 110-T is deployed in the field, this approach prevents anyone from degrading the TET 110-T to a NTET 110-N. As noted above, the signed TE file is included in the factory image (e.g., in the ISPDID) to designate whether a terminal is TE or not. Only the TET 110-T itself can read and interpret this secret information.

An aspect of secure registration of TETs 110-T is to prevent adversaries from accessing secure information about TETs 110-T and/or about the network. For example, a user terminal 110 to be used as a TET 110-T is loaded with digital certificates at the factory to support a TET's 110-T commissioning and registration procedure over HTTPS. However, as illustrated below, merely adopting digital certificates-based authentication and/or transport layer security (TLS) handshaking for secure HTTP does not tend to provide end-to-end registration security.

According to embodiments described herein, a TET 110-T obtains its link-layer key materials (including traffic session keys) after the completion of authentication and registration of the TET 110-T with the NMS 235. The session keys are used to protect outroute generic stream encapsulation (GSE) protocol data units (PDUs) and inroute time division multiple access (TDMA) bursts data. However, before this, operation of the TET 110-T still involves exchanging messages with the NMS 235, including sending and receiving management messages. These messages include some terminal-specific identities and information, and embodiments herein ensure that those terminal-specific identities are encrypted end-to-end.

On inroute, the TET 110-T first sends an unallocated burst communication to obtain stream bandwidth, so that it can send registration messages to the NMS 235. In one implementation, the burst communication is sent using the ALOHA (Additive Links On-line Hawaii Area) protocol. In a normal case, the TET 110-T includes context information in the unallocated burst to an inroute bandwidth allocator (IBA) which contains the ESN of the TET 110-T as the terminal identity. The IBA uses this information to create the terminal context for the purpose of allocating bandwidth and for correlating the reception of inroute bursts with the correct terminal.

Notably, if the terminal identity (ESN) is sent in the clear, adversaries can eavesdrop on the ESN and can later compromise the TET 110-T. Unfortunately, user terminals 110 only obtain their link-layer key materials after the completion of registration. As such, the user terminals 110 cannot encrypt the ESN in the unallocated burst that is sent to receive bandwidth allocation as part of the registration process (i.e., as part of sending registration-related messages to the NMS 235).

Embodiments herein perform registration initially with a fake ESN (f-ESN). Instead of using the real ESN as the user terminal's 110 context information during registration, the f-ESN is used as a temporary context until the user terminal 110 obtains its link-layer keys.

The TET 110-T selects an inroute set that supports TETs 110-T. The indication that an inroute set can be used by TETs 110-T can be provided by the IBA via a flag in the inroute set definition message. In this context, an inroute set is a predefined group of frequency channels and time slots used for transmitting data from user terminals 110 back to the satellite 105 and ultimately to the ground station 120. This configuration allows for efficient and organized management of the return link, ensuring that data from multiple user terminals can be transmitted without interference. The IBA is a mechanism to allocate specific frequency channels and time slots within the inroute set to individual user terminals 110. The IBA is responsible for managing the available bandwidth and ensuring that each user terminal 110 is assigned the appropriate resources based on its communication needs and network conditions. The IBA can be managed by the NMS 235, or otherwise in the ground station 120.

To determine that an inroute set supports TRANSEC (Transmission Security), the IBA can evaluate several criteria. For example, it can check the configuration settings of the inroute set to ensure that TRANSEC encryption and decryption protocols are enabled, verifying that the necessary cryptographic algorithms and keys are in place. The IBA can then assess the capabilities of the user terminals 110 within the inroute set to confirm that TETs 110-T have the required hardware and software components (e.g., a TRANSEC module 215) to support secure communication. The IBA can also monitor data traffic within the inroute set to verify that all transmitted data is encrypted according to TRANSEC standards, checking that data packets are properly encrypted before transmission and decrypted upon reception. Additionally, the IBA can ensure that key management processes are functioning correctly, including the generation, distribution, and rotation of encryption keys. The IBA can then verify that the inroute set complies with the network's security policies and protocols, adhering to guidelines for secure data transmission, access control, and intrusion detection.

As noted above, instead of using a real ESN for terminal context, the TET 110-T provides the f-ESN. The f-ESN is sent according to a predefined packet format that allows the IBA to recognize the ESN as fake. In particular, a designated portion of the packet format (e.g., a designated bit) of the burst transmission indicates to the IBA whether the ESN is real or fake, thereby triggering the IBA to allocate stream bandwidth in an appropriate manner. In one implementation, consistent with using the ALOHA protocol for the burst transmission, a 32-bit packet format is defined as follows: The most significant bit is set to 1 to indicate to the IBA that this is a fake ESN so that the IBA accepts it and allocates stream bandwidth and can operate differently as required; the next 3-bits are reserved (e.g., always set to zero); the next 8-bits represents the inroute group identifier of the group from where the user terminal 110 selects its ALOHA aperture; the next 12-bits are used to convey the frame number (the least twelve significant bits of a full frame number), the frame which the terminal has selected for the ALOHA burst; and the next 8-bit represent which chronological ALOHA aperture within the inroute group the terminal is selected for transmission (e.g., assuming a maximum of 256 ALOHA apertures supported in one inroute group).

When “diversity ALOHA” is configured, the same f-ESN can be used with the ALOHA burst sent on a different frame. The number matching the earlier of the two diverse bursts can be used in both bursts. For example, sending the f-ESN in the above manner avoids collisions between user terminals 110 when multiple TETs 110-T are getting commissioned at the same time, or nearly at the same time, or overlapping each other in time. If two or more user terminals 110 select the same frame and the same ALOHA number within an inroute group, the ESN can be the same. However, in such a case, ALOHA collision will happen anyway, and all user terminals 110 will execute a random backoff for their retrying events (according to the ALOHA protocol).

In some embodiments, the inroute group identifier space is unique system wide. In other embodiments, the inroute group identifier space is unique only within a user beam, not system wide. Therefore, an IBA supporting multiple beams and inroute sets can have inroute groups from multiple beams, and therefore, inroute group identifiers may not be unique in the f-ESN. Although this will tend to be a rare event, the f-ESN from multiple user terminals 110 can collide during the overlapping commissioning time. In such an event, the IBA would think colliding messages are coming from the same user terminal 110 and would tend only to use the information it processes last. As such, the bandwidth would be allocated to one of the user terminals 110 and not to the other. Further, the other user terminal 110, being in a different beam, will not see the allocations. Embodiments treat this in the same manner as a typical ALOHA collision. User terminals 110 not getting the allocation will go back to an inactive state and will try subsequent ALOHAs. Due to random backoff in selecting an ALOHA channel, there is a negligible chance of a repeated ESN collision. Notably, using the above approach, it is not possible to have collision between a f-ESN and a real ESN.

One potential concern is that, if a TET 110-T is compromised, one could use many f-ESN requests to simulate a case of denial-of-service attacks on the IBA. To address this concern, the IBA can validate the f-ESN based on its structure by checking if the inroute group ID, frame number, and ALOHA number in the f-ESN are valid and legitimate (according to a known ALOHA configuration). Otherwise, the IBA can reject the burst.

Another potential concern is that one can send f-ESNs from a compromised TET 110-T that may collide with real ESNs. To address this concern, collision handling can be performed by the IBA in the same way as described earlier in the context of ESN collisions from TETs 110-T during registration.

Another potential concern relates to maintaining and cleaning up of reassembly buffers and/or terminal contexts in the IBA. Reassembly buffers are generally memory and data structures used to reassemble fragmented data packets as they are received by the IBA. For example, data packets are often broken into smaller fragments for transmission and need to be reassembled correctly upon arrival to ensure that the original data is accurately reconstructed. When a user terminal 110 receives fragmented packets, it stores these fragments in temporary memory areas called reassembly buffers. Maintaining these buffers involves tracking fragments, keeping track of which fragments have been received and which are still missing, storing the received fragments in the correct order, and handling timeouts by monitoring the time since the first fragment was received to ensure that reassembly is completed within a reasonable timeframe. If fragments are not received within this time, the process may be abandoned to free up resources.

Cleaning up reassembly buffers involves completing reassembly once all fragments of a data packet are received, processing it, and then clearing the buffer to free up memory for future packets. It also includes handling incomplete reassembly by discarding partial data and clearing the buffer if all fragments are not received within the expected time or if an error is detected, thus avoiding memory leaks and ensuring that the system can continue to function efficiently. Context management can involve removing any metadata or context information associated with the reassembly process to ensure that no residual data remains that could interfere with future reassembly processes. Effective maintenance and cleanup of reassembly buffers help to maintain system performance by handling incoming data efficiently without running out of memory or processing power, maintaining data integrity by preventing data corruption, and enhancing security by preventing potential vulnerabilities such as buffer overflow attacks where malicious data could exploit leftover data in the buffer.

In the described context, during registration, a user terminal 110 can go active and inactive multiple times. Each time the user terminal 110 becomes active, it may generate a new f-ESN, which is sent to the IBA via the context info. If the IBA were to employ the same policy in cleaning up unused contexts for both NTETs 110-N and TETs 110-T, the result can be an excessive number of reassembly buffer contexts being created for the f-ESN contexts within a noticeably brief period of time.

To address this concern, embodiments described herein provide a novel approach for IBA handling of cleanup when receiving a f-ESN. Embodiments of the IBA assign a temporary system-assigned identifier (T-SAI) when a user terminal 110 first sends the burst communication. As noted above, the burst communication indicates that it includes an f-ESN. In such cases, the IBA can track the f-ESN to the user terminal's 110 T-SAI, and the IBA is configured to clean up contexts created for f-ESNs immediately when the user terminal 110 goes inactive. For example, as soon as the IBA detects that it has not received any bursts for that context for a predetermined threshold period of time (e.g., a user hold time), the IBA immediately cleans up the context for that user terminal 110. This avoids having many contexts active at the same time, which would unnecessarily consume system resources.

Techniques described above and further herein support a secure end-to-end registration process for TETs 110-T. Such a process can be compatible with conventional registration of NTETs 110-N, such as in a hybrid network having both TETs 110-T and NTETs 110-N.

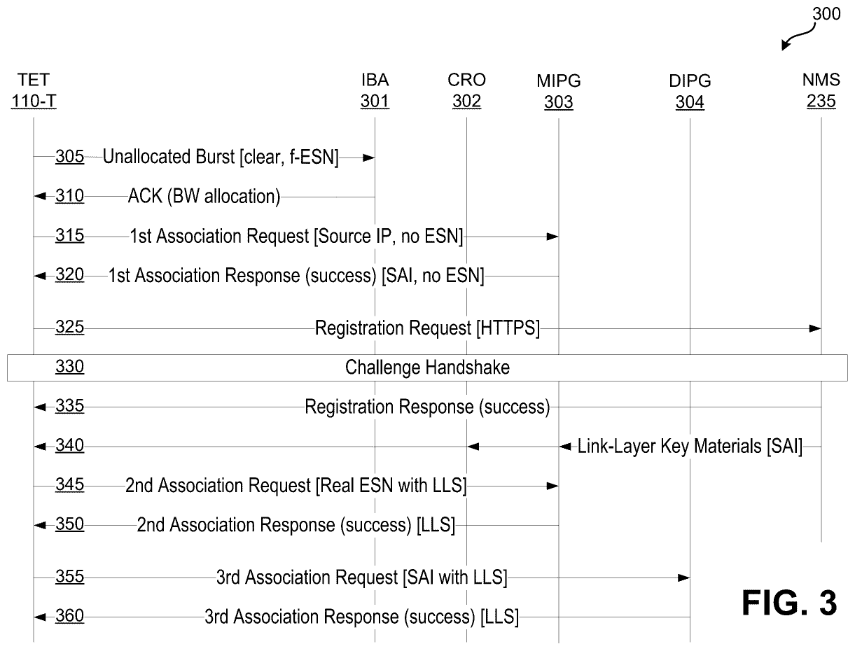

FIG. 3 shows a ladder diagram 300 for an illustrative secure terminal registration procedure, according to embodiments described herein. The ladder diagram 300 includes a TET 110-T, an IBA 301, and an NMS 235. Between the IBA 301 and the NMS 235, the ladder diagram 300 also shows a management Internet Protocol (IP) gateway (MIPG) 303 and a data IP gateway (DIPG) 304. All of the IBA 301, NMS 235, MIPG 303, and DIPG 304 are implemented in the ground station 120. In this context, the MIPG 303 and DIPG 304 are portions of an “IP gateway” (IPGW) that handle management traffic and user data traffic, respectively. The NMS 235 can function as a web server.

For added clarity, the ladder diagram 300 indicates signal communication stages 305-360. As described above, at stage 305, the TET 110-T sends an unallocated burst to the IBA 301. Because the TET 110-T has not yet been registered, the TET 110-T cannot secure its initial communications in a manner that would be understood end to end. Thus, the unallocated burst is sent in the clear (i.e., unencrypted, with terminal identifying information suppressed using the f-ESN). As described above, the unallocated burst includes a f-ESN and is configured to indicate that the ESN in fake in a manner that is understandable to the IBA 301 (e.g., using a designated bit, flag, etc.).

At stage 310, the IBA 301 responds to the unallocated burst by sending an acknowledgement message (ACK). The ACK is associated with the IBA 301 allocating bandwidth resources to the TET 110-T.

At stage 315, a first association procedure begins. The TET 110-T sends a first association request to the MIPG 303. There is still no link-layer security, and the first association request is sent without a real ESN. For example, the first association request identifies the TET 110-T by its source IP address (e.g., used for management traffic). As noted above, the MIPG 303 is a component of the ground station 120 that carries user terminals'110 management traffic.

At stage 320, assuming a successful association, the MIPG 303 sends a first association response. The MIPG 303 advertises an IPv6 management router advertisement (RA) over the air. The IPv6 RA is a type of message used in the IPv6 protocol to facilitate network configuration and management. It is part of the neighbor discovery protocol (NDP), which helps with address autoconfiguration, discovery of other network nodes, determining the reachability of these nodes, etc. Advertising the RA provides the user terminal's 110 management plane source IP address prefix. For an NTET 110-N, the last four bytes of its real ESN are typically used as the last four bytes of its derived management IP address.

As noted above, because no link-layer key information has been generated or received at this stage, no link-layer security can be applied to the first association response. For example, even if registration is performed over HTTPS, the IP header is in clear (unencrypted) when messages are exchanged between a TET 110-T and the MIPG 303; and the TET's 110-T IP address (along with any ESN information) would similarly be in clear. This is incompatible with TRANSEC.

In embodiments described herein, at stage 315, the TET 110-T constructs its source IP address from an advertised IPv6 prefix by randomly generating a 4-byte number. This constructed source IP address is provided as part of the first association message to the MIPG 303. The MIPG 303 retrieves this 4-byte number from the TET's 110-T source IP address and sends this number as a temporary system-assigned terminal identity (T-SAI) towards the entity which generates the outroute link-layer messages. On outroute, management packets are sent following generic stream encapsulation (GSE) with the T-SAI (the random 4-byte number) used as the GSE address. The TET 110-T accepts its packets, which have the GSE protocol data unit (PDU) address of the T-SAI, by matching the number it had used to derive its management plane source IP address.

Upon successful association with the network, the TET 110-T proceeds to register with the NMS 235. As stage 325, the TET 110-T sends a registration request to the NMS 235 using HTTPS. This request contains a unique (but still temporary) identifier for the TET 110-T (e.g., the T-SAI), configuration details, and any required authentication credentials. HTTPS ensures that the data transmitted is encrypted, which provides application layer security (e.g., using TLS, secure socket layer (SSL), etc.). Notably, use of HTTPS does not provide link-layer security.

At stage 330, responsive to the registration request at stage 325, the TET 110-T and the NMS 235 engage in a challenge handshake routine. This routine is a security mechanism designed to verify the authenticity of the TET 110-T and the network. The NMS 235 sends a challenge to the TET 110-T, typically a random string or nonce. The TET 110-T then responds with a cryptographic proof, such as a digital signature or hash, generated using its private key and the received challenge. This proof is sent back to the NMS 235 within a specified time frame. The NMS 235 verifies the response using the TET's 110-T public key, ensuring that the request is from a legitimate and trusted source.

At stage 335, upon successful verification of the challenge response, the NMS 235 sends a registration response back to the TET 110-T (again using HTTPS). This response includes confirmation of successful registration and can include additional configuration parameters. In connection with the registration response, link-layer key materials and a real SAI for the terminal are generated and sent from the NMS 235 to the TET 110-T at stage 340. Although shown as separate stages, stages 335 and 340 can be a single stage. Because there is still no link-layer security, the link-layer key materials and the real SAI can be sent using the T-SAI.

Once the TET 110-T completes its registration process and obtains its link-layer key materials, it can now implement link-layer (end-to-end) security. The TET 110-T changes its management plane source IP address by appending its real ESN into the prefix. Subsequently, all management messages can be delivered with the TET's 110-T real ESN as the GSE address for terminal identification. As of this stage, all management messages are encrypted over the air including the terminal identity in the message using link-layer security (LLS) based on the link-layer key materials. The TET 110-T can now listen to the GSE address that is its real ESN.

At stage 345, following the completion of the initial registration process, the TET 110-T initiates a second association request with the MIPG 303 (indicating that TET 110-T is a TE terminal). This time, the request includes the real ESN sent using LLS. As noted above, the LLS ensures that communication of the ESN is encrypted at the link-layer, providing end-to-end security. This second association request seeks to establish a secure and authenticated link between the TET 110-T and the management infrastructure (e.g., the MIPG 303), ensuring that all subsequent communications are protected against eavesdropping and tampering.

At stage 350, the system responds to the second association request with a second association response. This response confirms the successful establishment of a secure association using the real ESN and LLS. The acknowledgment from the system indicates that the link-layer security is now active, and the TET 110-T can securely communicate with the network management system. The response may also include additional configuration parameters and security keys that further enhance the security and integrity of the communication.

At stage 355, the TET 110-T can initiate a third association request, this time with the DIPG 304. This request sends the real SAI (i.e., assigned by the system after registration) using LLS. At stage 360, the DIPG 304 responds to the third association request with a third association response. As described above, the SAI was generated as an identifier that can be used for routing and managing traffic within the network, including data traffic. The third association exchange can ensure secure communication of user data traffic.

Notably, the process described in FIG. 3 is compatible with conventional association and registration for NTETs 110-N, such as in hybrid networks having both NTETs 110-N and TETs 110-T. In particular, the process described in FIG. 3 can be implemented to implement TRANSEC for TETs 110-T without adding any overhead to NTET 110-N communications. For example, for an NTET 110-N, the unallocated burst is sent in stage 305 with the real ESN for the NTET 110-N. Accordingly, the bandwidth allocation in stage 310 is associated with the real context information for the requesting NTET 110-N. Similarly, the association and registration routines of stages 315-340 can be performed for the NTET 110-N in a similar manner as for the TET 110-T, except that the routines use the real ESN from the start. As such, for an NTET 110-N, there is no need to perform re-association stages 345-360.

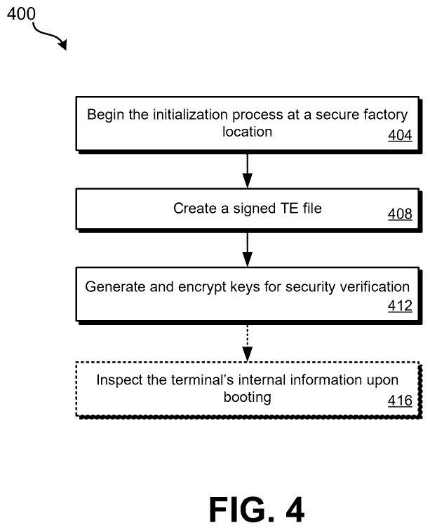

FIG. 4 shows a flow diagram of an illustrative method 400 for initial configuration of a TRANSEC-enabled terminal (TET), according to embodiments described herein. The method 400 begins at stage 404 by initializing the TET at a secure factory location. A user terminal 110 is designated as a TRANSEC-enabled terminal (TET 110-T) by a trusted agent (TA). The TA includes a group of secret information in the terminal's factory image, which identifies the terminal as a TET 110-T. This secret information is only accessible by the terminal's software. Additionally, each TET 110-T is uniquely associated with a Terminal Master Key (TMK) and an Electronic Serial Number (ESN) of its internal circuitry, such as an application-specific integrated circuit (ASIC). The TA burns the TMK and the ESN into a secure memory location that only the specific TET 110-T can access.

At stage 408, embodiments can create a signed TE file. If the user terminal 110 is determined to be a TET 110-T, a signed TE file is generated and incorporated into the terminal's factory image. This file is not visible in the flash file system and is secret to others. The signed TE file may be burned into the factory image as part of establishing the terminal's in-system programmable device identifier (ISPDID). This identifier includes essential firmware, software drivers, initial settings, and security features, ensuring that only the TET 110-T can read and interpret the signed TE file.

At stage 412, embodiments can generate and encrypt keys for security verification. A well-known string is signed by generating a 256-bit key called the signature master key (SMK). The SMK is then encrypted by the TMK to produce the encrypted signature master key (ESMK). A well-known clear string (KS) is encrypted by the SMK, resulting in the encrypted well-known string (EKS). These encrypted keys are stored in the factory image, ensuring that the terminal can verify its own security credentials upon booting.

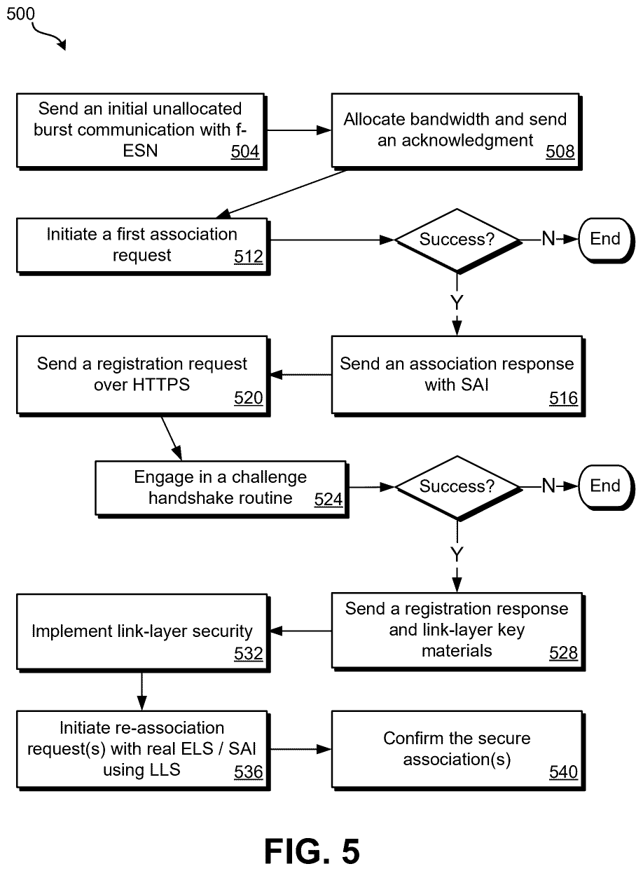

In some embodiments, at stage 416, embodiments can inspect the terminal's internal information upon booting. Every time the user terminal 110 boots up, it checks for the presence of the signed TE file. If the file is not found, the terminal operates as a non-TRANSEC-enabled terminal (NTET 110-N). If the file is present, the terminal decrypts the ESMK using the TMK to retrieve the SMK, and then decrypts the EKS using the SMK to obtain the KS. If successful, the terminal identifies itself as a TET 110-T and prepares for secure communication (e.g., according to the method 500 of FIG. 5).

FIG. 5 shows a flow diagram of an illustrative method 500 for initializing a TRANSEC-enabled terminal (TET) for secure communications in a satellite communication network, according to embodiments described herein. The method 500 begins at stage 504 by sending an initial unallocated burst communication to a ground terminal 120 via a satellite 105 (e.g., based on the ALOHA protocol, or the like). For example, the TET 110-T sends an unallocated burst communication to an inroute bandwidth allocator (IBA) to obtain stream bandwidth. This burst includes a fake ESN (f-ESN) to temporarily identify the terminal until it obtains its link-layer keys. The burst is configured to indicate that the ESN is fake, which the IBA recognizes and processes accordingly.

At stage 508, embodiments can allocate bandwidth and send an acknowledgment. The ground terminal 120 (e.g., IBA) responds to the unallocated burst by allocating bandwidth resources and sending an acknowledgment message (ACK) to the TET 110-T. This allocation allows the terminal to proceed with the registration process.

At stage 512, embodiments can initiate a first association request. The TET 110-T sends a first association request to the ground terminal 120 (e.g., to a management Internet Protocol gateway (MIPG) 303). This request is sent without link-layer security and uses a randomly generated 4-byte number as part of its source IP address. The MIPG 303 retrieves this number and sends it as a temporary system-assigned terminal identity (T-SAI) towards the entity that generates the outroute link-layer messages.

At stage 516, embodiments can send a first association response. As illustrated, there can be a determination of whether the first association request in stage 512 is successful. If not, the method 500 can end; if so, (i.e., upon successful association), the ground terminal 120 (e.g., MIPG 303) sends the first association response at stage 516. For example, the first association response includes an over-the-air IPv6 management router advertisement (RA). This RA provides the user terminal's management plane source IP address prefix, enabling the terminal to construct its source IP address from the advertised prefix. The TET 110-T can determine the T-SAI (explicitly or implicitly) from the first association response.

At stage 520, embodiments can send a registration request over HTTPS. The TET 110-T sends a registration request to the ground terminal 120 (e.g., to the NMS 235) using HTTPS. The request can include the T-SAI, configuration details, and any required authentication credentials. HTTPS ensures that the transmitted data is encrypted, providing application layer security (but not link-layer security).

At stage 524, embodiments can engage in a challenge handshake routine. In response to the registration request, the ground terminal 120 (e.g., the NMS 235) sends a challenge to the TET 110-T. For example, the TET 110-T responds with a cryptographic proof generated using its private key and the received challenge. The NMS 235 verifies this response using the terminal's public key to ensure the request is legitimate.

At stage 528, embodiments can send a registration response and link-layer key materials. As illustrated, there can be a determination of whether the handshake routine in stage 524 is successful. If not, the method 500 can end; if so (i.e., upon successful verification), the ground terminal 120 (e.g., NMS 235) sends a registration response and link-layer key materials to the TET 110-T. These materials include a real SAI and encrypted traffic session keys.

At stage 532, embodiments can implement link-layer security. The TET 110-T changes its management plane source IP address by appending its real ESN into the prefix. All subsequent management messages are encrypted over the air using link-layer security (LLS) based on the link-layer key materials. The terminal can now securely communicate with the network.

At stage 536, embodiments can initiate one or more re-association requests using LLS. The TET 110-T sends each additional association request to the ground terminal 120 including the real ESN and using LLS. At stage 540, embodiments (e.g., the ground terminal 120) can confirm the secure association. The ground terminal 120 responds with one or more re-association response(s) responsive to the one or more re-association requests, each confirming the successful establishment of a secure association using the real ESN and LLS. Each response may include additional configuration parameters and security keys. The re-association request(s) and response(s) establish a secure and authenticated link between the terminal and the network.

In some implementations, the re-association request(s) and response(s) of stages 536 and 540 include a second association request sent from the TET 110-T to the MIPG 303 and a second association response received by the TET 110-T from the MIPG 303. The request and response use the real ESN and using LLS. This second association request and response establishes a secure and authenticated link between the terminal and the management infrastructure. In some implementations, the re-association request(s) and response(s) of stages 536 and 540 include a third association request sent from the TET 110-T to the DIPG 304 and a third association response received by the TET 110-T from the DIPG 304. In some implementations, the request and response use the SAI and LLS. This request and response ensure secure communication of user data traffic within the network.

As noted above, after LLS is established, embodiments use the real ESN of the TET 110-T for management-related communications and a real SAI for user-data-related communications. The ESN is a unique identifier that is permanently assigned to each terminal. Using the ESN helps to ensure that the management infrastructure can uniquely and consistently identify the TET 110-T across all management-related operations. For example, communication of configuration and control commands can rely on a stable and unique identifier. Conversely, the SAI is useful as an identifier for routing and managing user data traffic within the network without permanently binding to the TET's 110-T unique ESN. Using the SAI allows the network to efficiently handle and route data traffic, as it provides a flexible and context-specific identifier. This flexibility also supports dynamic network environments in which terminals may frequently join and leave the network. Further, use of the SAI for user-data-related communications can help to reduce the overhead associated with using the ESN.

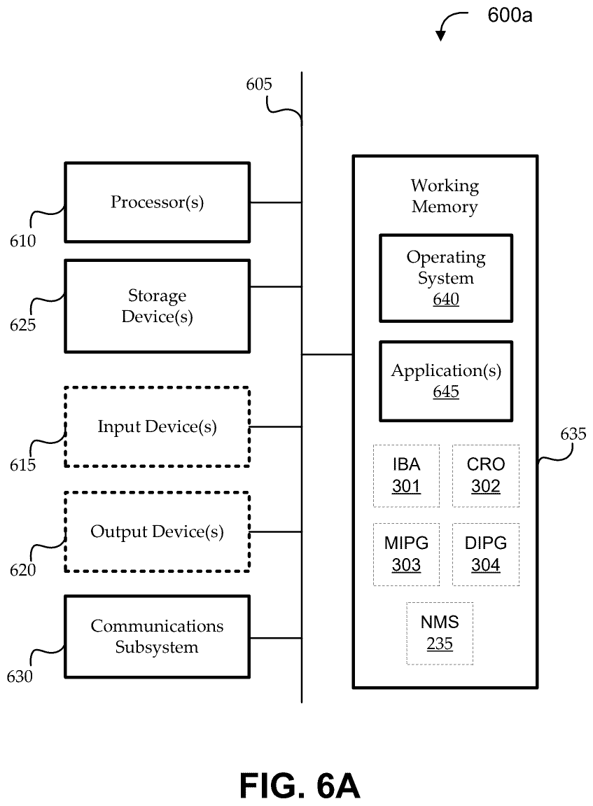

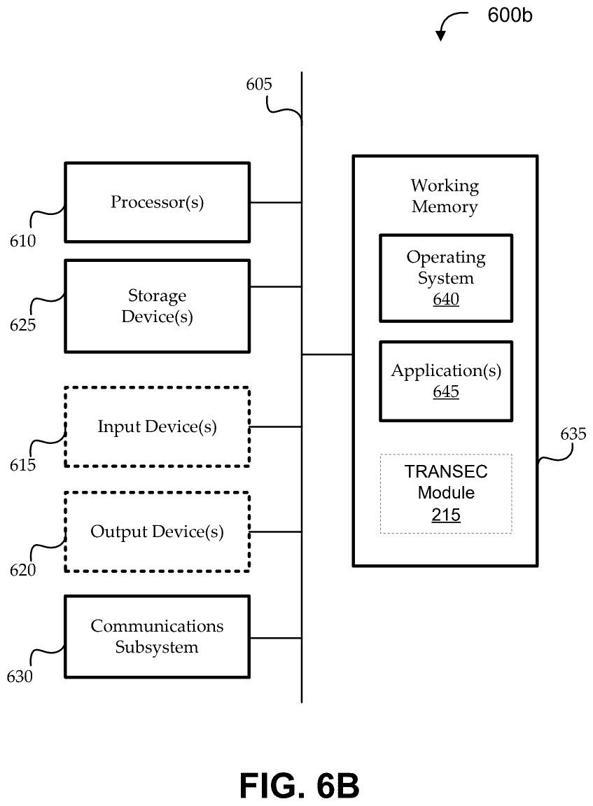

In some embodiments, components of the TET 110-T and/or the ground station 120 are implemented by a computational system. FIGS. 6A and 6B provide schematic illustrations of embodiments of computational systems 600 that can implement various system components and/or perform various steps of methods provided by various embodiments. The computational system 600a of FIG. 6A can be an implementation of a TE ground station 120, and the computational system 600b of FIG. 6B can be an implementation of a TET 110-T. FIG. 6 A and 6B are meant only to provide a generalized illustration of various components, any or all of which may be utilized as appropriate. FIGS. 6A and 6B, therefore, broadly illustrates how individual system elements may be implemented in a relatively separated or relatively more integrated manner.

The computational system 600 is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as digital signal processing chips, graphics acceleration processors, video decoders, and/or the like). Optionally, embodiments of the computational system 600 can include one or more input devices 615, and/or one or more output devices 620. The input devices 615 can include user input devices (e.g., a mouse, a keyboard, remote control, touchscreen interfaces, audio interfaces, video interfaces, and/or the like) and/or machine input devices (e.g., computer-to-computer interfaces, such as wired and/or wireless input data ports). Similarly, the output devices 620 can include user output devices (e.g., display devices, printers, and/or the like), and/or machine input devices (e.g., computer-to-computer interfaces, such as wired and/or wireless output data ports).

The computational system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 625 include memory for storing encryption keys, encrypted data, and/or other information used by embodiments to implement features described herein.

The computational system 600 can also include a communications subsystem 630, which can include, without limitation, a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. Depending on where in the network the computational system 600 is deployed, the communications subsystem 630 can include any suitable hardware and/or software components for communicating with other salient portions of the network.

In some implementations of computational system 600a, the communications subsystem 630 includes components for interfacing with a satellite network (e.g., antenna system 220-G, modem/router 210-G) and/or for interfacing with terrestrial backhaul networks and/or other networks. In some implementations of computational system 600b, the communications subsystem 630 includes components for interfacing with a satellite network and/or for interfacing with local networks, user networks, and/or other networks. For example, computational system 600b can include some or all of antenna system 220-T and/or modem/router 210-T.

The computational system 600 further includes a working memory 635, which can include a RAM or ROM device, as described herein. The computational system 600 also can include software elements, shown as currently being located within the working memory 635, including an operating system 640, device drivers, executable libraries, and/or other code, such as one or more application programs 645, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the operating system 640 and the working memory 635 can be used in conjunction with the one or more processors 610 to implement the some or all of the initialization and secure registration processes for TRANSEC-enabled terminals.

For example, in implementations of computational system 600a, the working memory 635 can be used in conjunction with the one or more processors 610 to implement the some or all of the IBA 301, CRO 302, MIPG 303, DIPG 304, NMS 235, etc. In implementations of computational system 600b, the working memory 635 can be used in conjunction with the one or more processors 610 to implement the some or all of the TRANSEC module 215.

A set of these instructions and/or codes can be stored on a non-transitory (or non-transient) computer-readable storage medium, such as the non-transitory storage device(s) 625 described above. In some cases, the storage medium can be incorporated within a computer system, such as computational system 600. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 600 and/or can take the form of source and/or installable code, which, upon compilation and/or installation on the computational system 600 (e.g., using any of a variety of generally available compilers, installation programs, compression/decompression utilities, etc.), then takes the form of executable code.

In some embodiments, the computational system 600 implements a portion of a system for communicating a data signal in a wireless communication network, as described herein. In some embodiments, the non-transitory storage device(s) 625 can have instructions stored thereon, which, when executed, cause the processor(s) 610 to perform steps of the method 500 of FIG. 5.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 600) to perform methods in accordance with various embodiments of the invention. According to a set of embodiments, some or all of the procedures of such methods are performed by the computational system 600 in response to processor 610 executing one or more sequences of one or more instructions (which can be incorporated into the operating system 640 and/or other code, such as an application program 645) contained in the working memory 635. Such instructions may be read into the working memory 635 from another computer-readable medium, such as one or more of the non-transitory storage device(s) 625. Merely by way of example, execution of the sequences of instructions contained in the working memory 635 can cause the processor(s) 610 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 600, various computer-readable media can be involved in providing instructions/code to processor(s) 610 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 625. Volatile media include, without limitation, dynamic memory, such as the working memory 635. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a disk of a remote computer. The remote computer can load the instructions into its dynamic memory and send the instructions as signals over a transmission medium to be received and/or executed by the computational system 600. The communications subsystem 630 (and/or components thereof) generally will receive signals, and the bus 605 then can carry the signals (and/or the data, instructions, etc., carried by the signals) to the working memory 635, from which the processor(s) 610 retrieves and executes the instructions. The instructions received by the working memory 635 may optionally be stored on a non-transitory storage device 625 either before or after execution by the processor(s) 610.

### III. Link-Layer Traffic Flow Without TRANSEC

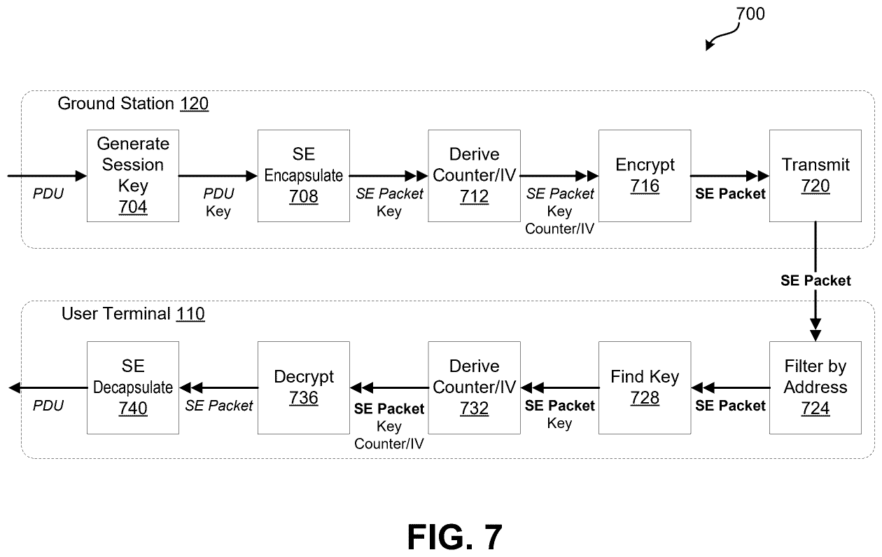

Some embodiments described herein provide inroute and/or outroute communications with link-layer security in a manner that supports TRANSEC and TRANSEC-enabled terminals (TETs). For example, such embodiments can operate in hybrid network with both TETs and NTETs in a manner that facilitates TE communications with TETs without adding overhead to NTE communications with NTETs. For context, FIGS. 7-10B illustrate traffic flow through a link-layer security mechanism without TRANSEC, including cryptographic (crypto) engines involved at different stages.

FIG. 7 shows a traffic flow diagram 700 for outroute traffic through a link-layer security path without TRANSEC. In the flow diagram 700, stages 704-720 are performed at the ground station 120 side (e.g., by ground station 120 of FIG. 1 or FIG. 2, or any suitable satellite gateway), and stages 724-740 are performed at the user terminal 110 side (e.g., by user terminal 110 of FIG. 1 or 2). As illustrated, in the outroute direction, a link-layer security process can begin at stage 704 by associating an appropriate key with the protocol data unit (PDU) to be sent. This is the responsibility of a sending component's satellite transmit module. As used herein, the term “protocol data unit” or “PDU” generically refers to the payload; it should not be confused with the term “packet,” which is used herein to describe link-layer messages.

Several ground station 120 components send outroute traffic (i.e., act as “sending components”). One is the data IP gateway (e.g., DIPG 304 of FIG. 3). Another is the IBA (e.g., IBA 301 of FIG. 3, or inroute group manager, IGM), which sends messages to the terminals related to inroute bandwidth management. Another is the management gateway (e.g., MIPG 303 of FIG. 3), which acts as a relay for the various NMS (e.g., NMS 235 of FIGS. 2 and 3) components, such as the Key Management Server or Key Dispatcher, which send messages to the terminals. Others are the timing synchronization application (TSA) and the satellite gateway code rate organizer (CRO, such as CRO 302 of FIG. 3), which send messages used by the terminals to synchronize inroute traffic transmission. The CRO also sends system information (e.g. User Beam ID, Outroute Timestamps, etc.) needed by all the user terminals.

Keys are generally associated with MAC addresses for the PDUs. As such, association of the key with the PDU in stage 704 is performed after a spacelink outroute MAC address for the PDU has been determined. Once the key has been generated, the outroute sender encapsulates the PDU and sends an outroute dataset having the encapsulated PDU and the associated key to the ground station 120. For example, the outroute dataset are sent according to a protocol format between the IP gateway and the CRO. When the ground station 120 receives the outroute dataset, it extracts the PDU(s) it contains and enqueues the PDU(s) for outroute transmission.

At stage 708, when the time comes to transmit a PDU, the ground station 120 encapsulates the PDU using a stream encapsulation (SE) protocol. In some embodiments, the SE is implemented as the Generic Stream Encapsulation (GSE) protocol, which is a standard protocol used in DVB-S2 or DVB-S2X for efficiently encapsulating network layer packets into a continuous stream for satellite transmission. The SE protocol (e.g., GSE) helps to reduce overhead, while supporting packet fragmentation and reassembly. Doubled arrows (including the doubled arrow exiting stage 708) are used to indicate that a PDU can be split into multiple SE packets.

At stage 712, the ground station 120 generates an appropriate counter or initialization vector (IV) for use in encrypting the SE packet. Then the SE packet, the counter/IV, and the key associated with the PDU encapsulated in the SE packet are passed to hardware for transmission. At stage 716, the counter/IV and the key are used to encrypt the SE packet payload. The SE header is not encrypted. The encryption at stage 716 can be performed by an FPGA-based crypto engine of an outroute modulator module. For added clarity, clear (unencrypted) data is shown in italics, and encrypted data is shown in bold. For example, the SE packet is shown in italics prior to stage 716 and in bold after.

At stage 720, the encrypted SE packet is transmitted by the ground station 120 via one or more forward satellite links to one or more user terminals 110.

On the user terminal 110 side, as each SE packet is received from the outroute. At stage 724, downlink firmware looks at the MAC address in the SE header to determine whether to accept the SE packet. The downlink firmware maintains a list of all the outroute MAC addresses, unicast and multicast, that this user terminal 110 is enabled to receive, along with the current Session Key associated with the address of the SE packet.

At stage 728, if the MAC address is found in the list, the downlink firmware checks to see if the SE packet is encrypted. Whether or not the SE packet is encrypted is indicated by the presence or absence of a crypto extension header. If the SE packet is encrypted, the firmware checks to see if there is a decryption key associated with the address.

At stage 732, if a key exists, the firmware, using the appropriate information in the SE header, derives the counter/IV needed to decrypt the payload. The SE packet payload, the key, and the counter/IV are passed to the downlink hardware crypto engine for decryption at stage 736.

At stage 740, after the payload is decrypted at stage 736, the SE encapsulation of the PDU is removed. The original PDU (e.g., an IP packet) is forwarded to the user terminal's 110 main processor.

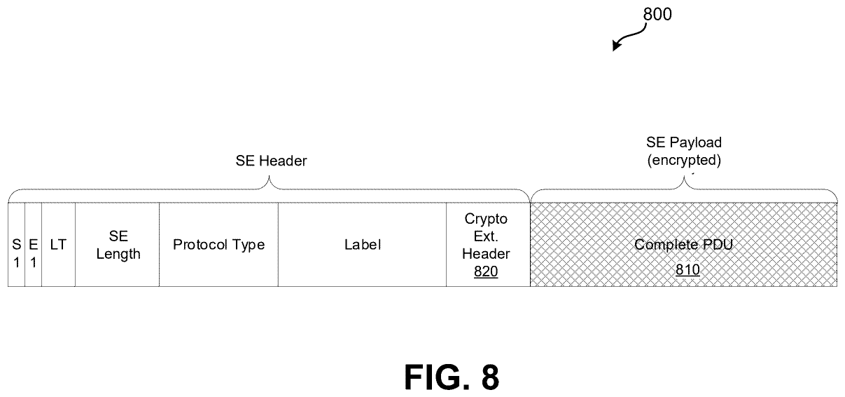

FIG. 8 shows an illustrative packet format 800 for an encrypted SE packet without TRANSEC. The illustrated SE packet format 800 is compatible with the GSE format. As noted above, only the PDU portion 810 of the SE packet is encrypted. The fact that a particular PDU is encrypted is indicated (to the receiver) by the inclusion of one of the SE Crypto Extension Header 820 variants in the GSE header. The Crypto Extension Header 820 is used to carry the portion of the counter or IV which is sent per PDU over the air interface.

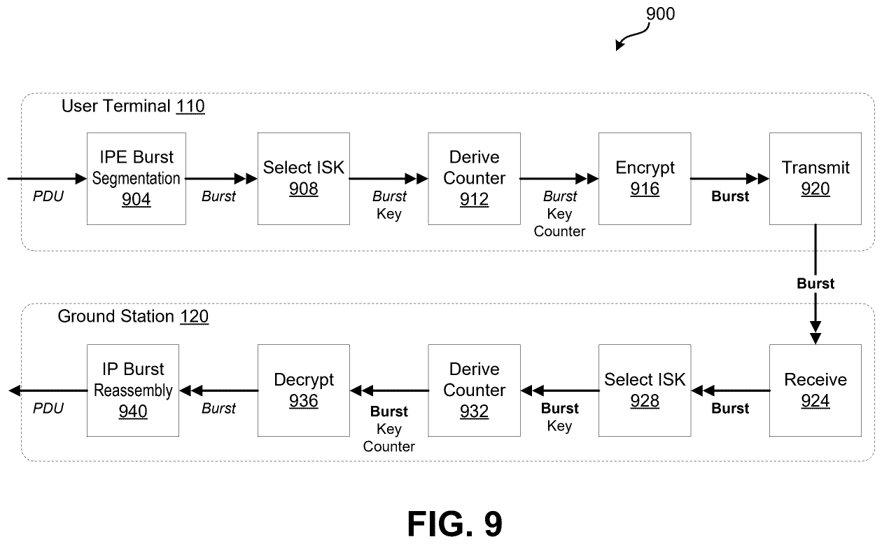

FIG. 9 shows a traffic flow diagram 900 for inroute traffic through a link-layer security path without TRANSEC. In the flow diagram 900, stages 904-920 are performed at the user terminal 110 side, and stages 924-940 are performed at the ground station 120 side. The description of flow diagram 900 is limited to AES CTR (Advanced Encryption Standard in Counter) mode. AES CTR mode is a standard method in DVB-S2 for encrypting data streams to ensure secure transmission. In general, the AES CTR mode transforms an AES block cipher into a stream cipher by combining a nonce (a unique, one-time initialization vector) with a counter that increments for each block of data, thereby producing a unique keystream for encrypting and decrypting data blocks. Further, an aspect of inroute link-layer security design is that encryption is typically performed at the IBE (inroute burst encapsulation) level, not at the IPE (inroute packet encapsulation) level, such as at the packets or PDU level. Thus, inroute encryption can function independent from and transparent to, for example, any fragmentation or retransmission happening at the IPE layer.

As illustrated, in the inroute direction, a link-layer security process for a PDU can begin at stage 904 by converting the PDU into one or more bursts. For example, a PDU can be split into multiple bursts, and/or a single burst can contain at least parts of multiple PDUs.

At stage 908, an Inroute Session Key (ISK) is selected. In the inroute direction, two options are supported (by the link-layer security design) with respect to strength of encryption. A first option is the use of a common shared ISK for all inroute traffic. The shared common ISK is provided to the user terminal 110 with its other session keys by a Key Management Server. A second option is the use of a unique ISK per terminal with per terminal ISKs only supported by TRANSEC-Enabled (TE) terminals. As described below, TE terminals can still use a shared ISK in some cases, such as when sending an unallocated burst because the IGM does not know which terminal sent the burst until after decryption. For Non-TRANSEC-Enabled (NTE) terminals, there is no need for the uplink firmware to associate, on the fly, an appropriate key with the packet or burst to be sent. Whether or not the ISK is shared or unique is transparent to the user terminal 110. TE terminals can choose between the use of the common shared ISK or the user terminal's 110 unique per terminal ESN-based key. The per terminal SAI-based key is not used in the inroute direction.

At stage 912, a counter is derived. At stage 916, the ISK and counter are used to encrypt the burst. At stage 920, the encrypted burst is transmitted over one or more satellite links to a ground station 120.

At stage 924, as each burst is received from an inroute, the ground station 120 (an Inroute Group Manager module, IGM) checks to see if the burst is encrypted. Encryption can be indicated by the absence or presence of the encryption counter. In general, the IGM receives the burst. In addition to the DIPG (and the IGM itself), the MIPG acts as a relay for various NMS components which receive messages from the user terminals 110. Terminal satellite access (TSA) and the CRO functions can also receive input from user terminals 110 as part of closed loop timing operation; however, this input is sent to and processed by the IGM, with the IGM forwarding the processed information to the TSA or CRO, not the raw terminal input. Thus, from a link-layer security point of view, the IGM can be considered as the only receiver of inroute traffic. Other receivers tend only to receive traffic from the user terminals after it has been decrypted by the IGM.

At stage 928, if the burst is encrypted, the ground station 120 (e.g., the IGM) determines the appropriate ISK to use. If the system is operating in shared ISK only mode, the ground station 120 uses the shared ISK. As described below, if there are TRANSEC-Enabled terminals, embodiments of the ground station 120 select an appropriate key based on the type of burst. If the system is operating with unique per terminal ISKs, the ground station 120 derives the appropriate ISK using the Root Session Key.

At stage 932, the ground station 120 (e.g., using the appropriate information in the IBE header) derives the counter needed to decrypt the burst. At stage 936, the ground station 120 passes the burst payload, the ISK, and the counter to a crypto engine (e.g., in the IGM) for decryption. At stage 940, after the payload is decrypted, the burst encapsulation of the packet is removed, and the original burst is processed. In the event of the PDU having been split into multiple bursts, the PDU is reconstructed as part of stage 940.

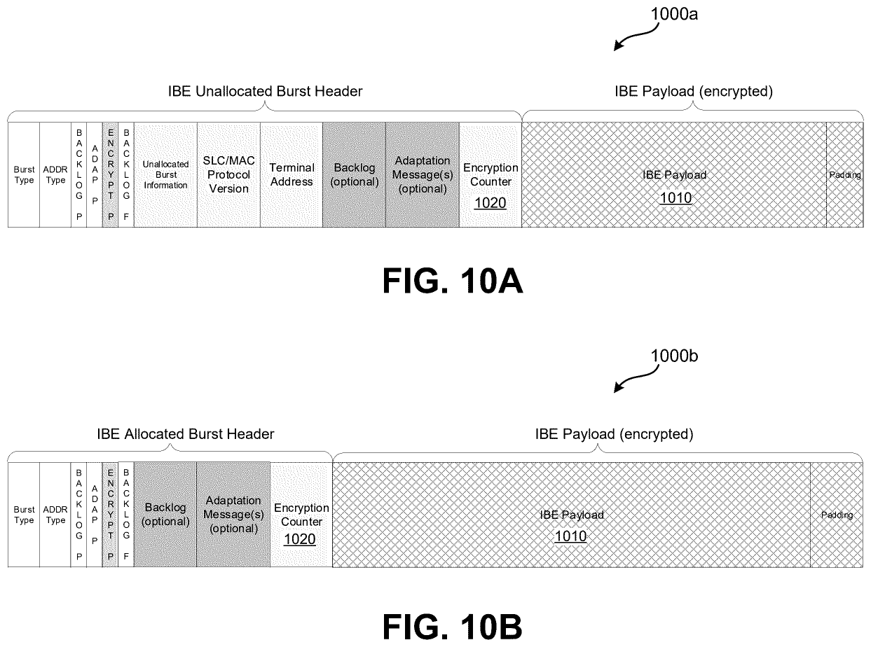

FIGS. 10A and 10B show two illustrative packet formats 1000 for an encrypted burst without TRANSEC. In FIG. 10A, the illustrated packet format 1000a is for an encrypted unallocated burst without the use of TRANSEC. In FIG. 10B, the illustrated packet format 1000b is for an encrypted allocated burst without the use of TRANSEC. From an encryption point of view, the unallocated and allocated bursts are identical. Only the fields included in the IBE header differ.

As described with reference to FIG. 8, only the payload portion 1010 of the burst is encrypted. The IBE payload does include IPE headers, as well as PDUs. The IBE header fields are sent in the clear. Padding, if present, is encrypted with the payload. The fact that a particular burst is encrypted is indicated (to the receiver) by the inclusion of the IBE Encryption Counter field 1020. The IBE Encryption Counter field 1020 is used to carry the portion of the counter which is sent per burst over the air interface.

### IV. Secure Masking of Channel Activity with Link-Layer TRANSEC

Link-layer TRANSEC goes beyond just protecting user data confidentiality to also protect user data identity. The key idea is to prevent an interceptor of the outroute or inroute traffic from determining to or from which individual terminal the user data was sent. Even without being able to see the user data itself, an adversary can learn information about a terminal from traffic patterns sent by the terminal. TRANSEC attempts to prevent the ability to do this. This primarily involves encrypting important parts of the link-layer headers rather than just the link-layer payload.

Particularly in hybrid networks having both TRANSEC-enabled and non-TRANSEC-enabled terminals (TETs and NTETs, respectively, as described above), an adversary may desire to discover which terminals are TETs, the locations of those TETs, how much traffic is going to those TETs, etc. Some embodiments described herein provide techniques for frustrating such adversarial objectives by securely masking channel activity at the link-layer for at least TETs. For example, embodiments can mask channel activity by hiding the volume of traffic being sent to each terminal, by grouping all TETs together to obfuscate which and/or how much traffic is going to which terminals, etc.

Some such embodiments provide such secure masking in a manner that is backwards compatible with, and does not add overhead to, conventional NTETs and their communications. Embodiments can provide secure masking of channel activity for inroute (inbound) communications and/or for outroute (outbound) communications. For example, without effective masking, inroute communications can be used by adversaries to reveal TET locations, and outroute communications can be used by adversaries to reveal how active TETs are.

### IV. A. Secure Masking of Outroute Channel Activity with Link-Layer TRANSEC

Embodiments described herein for implementing link-layer TRANSEC for outroute communications can include one or more of the following: enabling encryption of unicast management traffic; adding the ability to encrypt terminal-identifying information, which would otherwise be visible in Generic Stream Encapsulation (GSE) headers sent across the outroute; and/or supporting sending of constant-rate (e.g., constant bits per second or constant samples per second) traffic to each terminal. Enabling encryption for unicast management traffic is not described herein in detail because it can be performed without changing standard link-layer security implementations. For example, unicast management traffic can be encrypted by adding standard link-layer security features to a standard management gateway (e.g., MIPG 303 of FIG. 3) implementation. GSE modifications and constant-rate traffic support are discussed in more detail below.

### IV.A.1. GSE Modifications

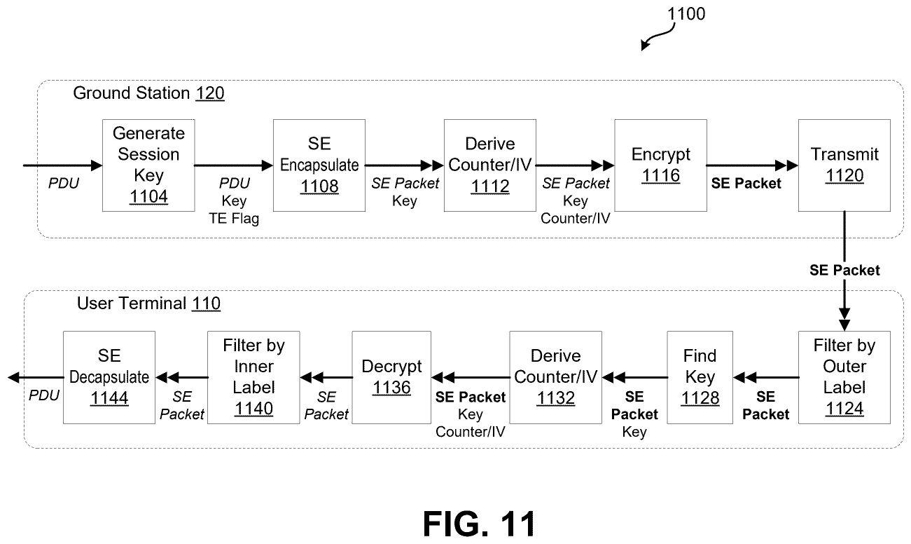

FIG. 11 shows an example outroute packet flow 1100 through a link-layer security path with TRANSEC encryption, according to embodiments herein. In the flow diagram 1100, stages 1104-1120 are performed at the ground station 120 side (e.g., by ground station 120 of FIG. 1 or FIG. 2, or any suitable satellite gateway), and stages 1124-1144 are performed at the user terminal 110 side (e.g., by user terminal 110 of FIG. 1 or 2). As illustrated, in the outroute direction, a link-layer security process can begin at stage 1104 by associating an appropriate key with the protocol data unit (PDU) to be sent. This is the responsibility of a sending component's satellite transmit module. This can be implemented in substantially the same manner as stage 704 of FIG. 7, except that generating the session key in stage 1104 further includes asserting a TRANSEC-enabled indicator (TE flag). The TE flag is sent by an outroute sender to the CRO (e.g., CRO 302 of FIG. 3) to trigger the CRO to use a TRANSEC variant of SE encapsulation (referred to as SE-T), which is described herein. In some implementations, use of SE-T only applies to unicast traffic since the address for multicast traffic does not identify individual terminals. The signal to use SE-T (i.e., the TE flag) can be included in an outroute dataset, along with the PDU and an associated encryption key.

As noted with reference to FIG. 7, keys are generally associated with MAC addresses for the PDUs. As such, association of the key with the PDU in stage 1104 is performed after a spacelink outroute MAC address for the PDU has been determined. Once the key has been generated, the outroute sender encapsulates the PDU and sends the outroute dataset to have the encapsulated PDU, along with the associated key and the TE flag. When the ground station 120 (e.g., CRO) receives the outroute dataset, it extracts the PDU(s) it contains and enqueues the PDU(s) for outroute transmission.

At stage 1108, when the time comes to transmit a PDU, the ground station 120 encapsulates the PDU using a stream encapsulation (SE) protocol. As noted above, if the TE flag indicates that this is TE data, the SE encapsulation in stage 1108 is according to the SE-T protocol.

Stages 1112-1120 can be performed in substantially the same manner as stages 712-720 of FIG. 7, except that the SE packet is formatted based on SE-T in the event that it carries TE traffic.

On the user terminal 110 side, as each SE packet is received from the outroute. At stage 1124, downlink firmware looks at an “outer label,” which is an unencrypted address field in the SE header, to determine whether to accept the SE packet. For non-TRANSEC traffic, the outer label address is the MAC address for the receiving NTE user terminal 110. For TRANSEC traffic, the outer label represents an address or label shared by multiple TE user terminals 110. In some implementations, there are two different possible outer labels corresponding to the use of two different unicast session keys that each terminal has. The downlink firmware maintains a list of all the outer label addresses, unicast and multicast, that this user terminal 110 is enabled to receive, along with the current Session Key associated with the address of the SE packet.

At stage 1128, if the outer label address is found in the list, the downlink firmware checks to see if the SE packet is encrypted. Whether or not the SE packet is encrypted is indicated by the presence or absence of a crypto extension header. If the SE packet is encrypted, the firmware checks to see if there is a decryption key associated with the address. At stage 1132, if a key exists, the firmware, using the appropriate information in the SE header, derives the counter/IV needed to decrypt the payload. The SE packet payload, the key, and the counter/IV are passed to the downlink hardware crypto engine for decryption at stage 1136.

After the payload is decrypted at stage 1136, non-TRANSEC SE packets can be passed directly to stage 1144, in which the SE encapsulation of the PDU is removed and the original PDU (e.g., an IP packet) is forwarded to the user terminal's 110 main processor. For TRANSEC SE packets, after the payload is decrypted at stage 1136, further filtering (e.g., software filtering) is performed on the packet based on an “inner label” at stage 1140. The inner label is a real label of the destination TE user terminal 110, which was encrypted during transit as part of the SE packet payload and is only available for software filtering after decryption of the payload at stage 1136. The correct destination TE user terminal 110 will know whether it is enabled to receive this SE packet based on the decrypted (e.g., and further decoded) inner label. Otherwise (i.e., if the receiving terminal is not the correct destination terminal), the SE packet can be discarded. The correct destination TE user terminal 110 can now, in stage 1144, remove SE encapsulation of the PDU and forward the original PDU to its main processor.

As noted above, embodiments apply link-layer TRANSEC to unicast traffic. Unicast management traffic is sent to a user terminal's 110 ESN-based Spacelink MAC Address. A user terminal 110 is already provided with a session key for this address. When link-layer TRANSEC is enabled, for TETs, the MIPG will encrypt the unicast management traffic it forwards to a user terminal 110. The MIPG, as an IP Gateway variant, is already provided with the Root Session Key needed to derive the user terminal's 110 management session key. The MIPG learns whether a terminal is a TET when the terminal associates with the MIPG. The user terminal 110 must have its session keys before telling any IP Gateway variant, including the MIPG, that it is a TET. Otherwise, it will not be able to decrypt the traffic sent to it. This means that at the transition point of receiving its session keys, the terminal must reassociate in order convert from NTE to TE status. Note that protection of user terminal 110 information prior to the user terminal 110 getting its keys relies on upper layer protocols (e.g., HTTPS).

Several features relating to link-layer encryption can be supported by default configurations of a satellite communication system. Such features can be supported by and/or compatible with the standard GSE protocol. For example, the entire GSE header, including the label (which identifies the user terminal 110) and the encryption counter, can be in the clear (i.e., not encrypted). The encryption counter does not need to be secret, as long as it is unique. The GSE payload can be encrypted with a per terminal key for unicast user and control traffic. In some implementations, the GSE payload is not encrypted for unicast management traffic. However, user terminals 110 can be provided with a session key for encrypting unicast management traffic. The GSE payload can be encrypted with a multicast group key for multicast user traffic using an IP Multicast feature. In some implementations, the GSE payload is not encrypted for multicast control traffic or multicast management traffic; any terminal specific information in the messages may be exposed.

For link-layer TRANSEC, embodiments described herein provide a new TRANSEC-enabled SE protocol, called SE-T, which is updated to support hiding the label for unicast traffic, thereby masking the identity of a receiving TET. The link-layer TRANSEC implementation can also be responsible for hiding user terminal 110 specific information in any multicast outbound message payloads which are generated by the link-layer. In some implementations, all such messages are related to management of inroute bandwidth, so hiding this information is discussed with in context of inroute link-layer TRANSEC design below. Hiding of terminal specific information in non-link-layer control messages and management messages generated above the link-layer can be enabled at the link-layer by providing the link-layer with the appropriate unicast or multicast session key for the message.

In some embodiments, DVB-S2X standards are used on outroute communications, including standard GSE encapsulation schemes. Either the user terminal's 110 ESN (for management traffic) or user terminal's 110 System Assigned Identifier (SAI) can be used in the GSE address for the purpose of filtering an outroute stream at the user terminal 110. For example, as described above, upon successful registration, embodiments the system assign a unique identifier to a terminal which is called SAI. Without TRANSEC, user terminal 110 identifiers can be sent in a clear GSE header.

The SE-T protocol is configured not to send user terminal 110 identity (e.g., the SE address) in the clear on the outroute. For the link-layer TRANSEC, the SE-T protocol supports hiding the label or address (user terminal 110 ID) for unicast traffic. Embodiments of the SE-T can also be responsible for hiding terminal specific information.

To protect the terminal label in unicast messages, the SE-T protocol is used in place of a regular SE protocol when the destination of a unicast packet is a TET. For example, when a traffic sender (e.g. an IP Gateway) indicates to the CRO that the destination of a unicast packet is a TET, the SE-T protocol is used. With SE-T, the real label for a PDU is moved to the other side of the encryption boundary to become an “inner label,” while the existing label (now an “outer label”) is used to signal to the user terminals 110 that the real label is now encrypted. As discussed below, the type of Spacelink MAC Address sent with the message can be used to determine which outer label to use.

When the user terminal 110 receives the SE-T packet, it uses one of its terminal specific keys to decrypt the packet. Which key to use is determined by the specific outer label value. After decrypting the packet, the user terminal 110 then checks the inner label, which has been placed in front of the encapsulated PDU, to determine if this packet is actually destined to itself (i.e., whether it is the intended recipient user terminal 110). If so, the PDU is forwarded onward for regular processing. If not, the packet can be discarded.

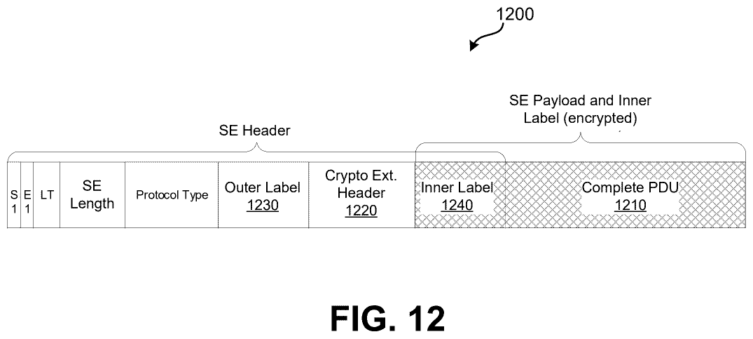

FIG. 12 shows an illustrative SE-T packet format for an encapsulated PDU, according to some embodiments. Here, both the PDU portion 1210 of the SE packet and the inner label 1240 are encrypted. The PDU portion 1210 can be considered as the SE payload, and the inner label 1240 as a portion of the SE header that is across the encryption boundary. As in a standard SE packet, the fact that a particular PDU is encrypted can be indicated (to the receiver) by the inclusion of one of the SE Crypto Extension Headers 1220 variants in the SE header. The Crypto Extension Header 1220 is used to carry the portion of the counter or IV which is sent per PDU over the air interface. As noted with reference to FIG. 11, initial (e.g., hardware) filtering of the SE packet upon receipt by a user terminal 110 is based on an outer label 1230, which is part of the unencrypted portion of the SE header.

As described above, this arrangement provides efficient decoding and compatibility for both TETs and NTETs. NTETs can easily decode SE packets to determine whether they are the intended recipient without having the additional overhead of having to decrypt the payload. The TETs, on the other hand, can tell from the outer label 1230 that they will need to decrypt the SE packet payload to find the inner label 1240, which they will need to use to determine whether they are the intended recipient.

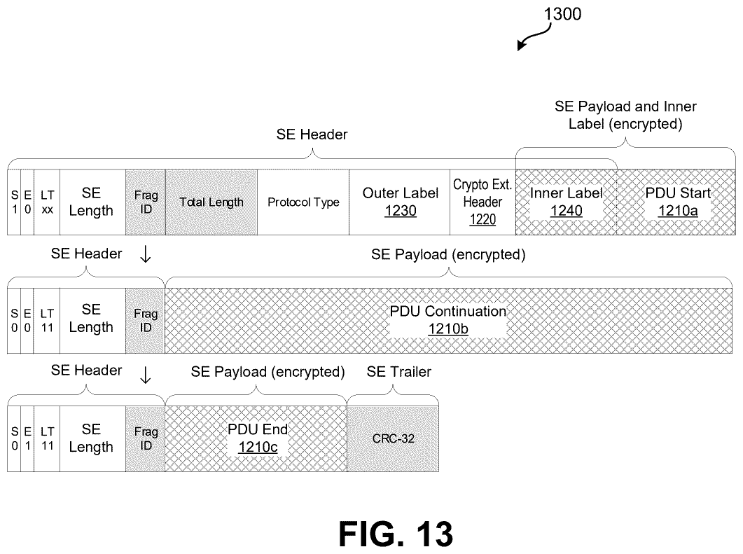

FIG. 13 shows an illustrative fragmented SE-T packet format for an encapsulated PDU, according to some embodiments. In general, reference herein to a SE-packet or SE-T packet can generally refer to either a fragmented or unfragmented packet. In general, the fragmented and unfragmented implementations of the packet formats are identical except as needed to support fragmentation. The illustrated fragmented SE packet in FIG. 13 includes three fragments: a starting fragment, a middle fragment, and an ending fragment. In general, such a fragmented packet can include fewer fragments (e.g., no middle fragment), or more fragments (e.g., any suitable number of middle fragments). The number of fragments and their sequence and relationship to each other can be indicated by fields of the packet format, such as by a “total length” field and “fragment ID” fields.

As in FIG. 12, both the PDU portion 1210 of the SE packet and the inner label 1240 are encrypted, and the outer label 1230 is unencrypted. As illustrated, the starting fragment of the packet can include the encrypted inner label 1240, the unencrypted outer label 1230, and a first part of the encrypted PDU portion 1210a. One or more middle fragments include one or more continuations of the encrypted PDU portion 1210b, and the ending fragment includes an end part of the encrypted PDU portion 1210c. As illustrated, the end of the SE packet can be incdicated by an SE trailer in the ending fragment. For example, the SE trailer includes a checksum, or other error detection mechanism.

As illustrated in FIGS. 12 and 13, a feature of the SE-T is that the inner and outer labels are both in the SE header, but on opposite sides of the encryption boundary. For NTETs, the actual label for the destination user terminal 110 is the outer label. For TETs, the actual label for the destination user terminal 110 is encrypted, while the visible outer label is changed to a value which the TET recognizes as a signal to decrypt the packet using a unicast decryption key because the packet might be destined to it. After decryption, the TET can look at the now decrypted inner label. If the inner label belongs to the TET, the PDU is forwarded for normal terminal processing. If the inner label does not belong to the terminal, the PDU can be discarded.

Some implementations assign each user terminal 110 two unicast decryption keys: one for user and control traffic, and one for management traffic. In such implementations, the SE-T is configured to use different outer label values to signal to the TET which encryption key was used. The CRO can determine which outer label to use based on the specific Spacelink MAC Address type provided for the user terminal 110. For example, the CRO already checks the type of address to determine whether it needs to use a 6-byte or 3-byte label to send the packet. ESN-based unicast Spacelink MAC Addresses can use a 6-byte label, whereas SAI-based unicast Spacelink MAC Addresses can be sent with a 3-byte label.

When selecting outer label values, implementations seek to avoid using values which might be in use as the equivalent of an inner label by either TETs or NTETs. For the outer label used with SAI-based Spacelink MAC Addresses, this can be achieved by using a value from the small set of Assign IDs defined for system use in related standards. For example, Assign IDs 0 through 255 are set aside for use by the system; but implementations may only use a particular subset (e.g., presently, values 0 through 3 are used with inroute bandwidth allocation signaling, and the others remain unassigned in this context).

For the outer label which will be used with ESN-based Spacelink MAC Address, embodiments seek to avoid overlapping a legitimate terminal ESN. In some embodiments, the ESN can theoretically be any 32-bit number. However, practical implementations tend to restrict the set of ESNs to a predetermined range. For example, a particular product may only use ESNs with values above 4,000,000, so that any value below 4,000,000 is acceptable for use as an outer label. Some implementations may carry additional considerations or constraints. For example, the Spacelink MAC Address design may require that ESN-based Spacelink MAC addresses are defined to be globably unique, so that each address is unique across all instantiations of the systems. To avoid implementing a separate ESN-based outer label for each instantiation of a system, embodiments can be configured to use a locally defined value, which can create a potential overlap with SAI-based addresses (since SAI-based Spacelink MAC Addresses are locally defined for each system instance). Such embodiments can avoid overlap by assigning the ESN-based outer label from a set of values guaranteed to be outside the range of valid values for all instantiations of the system. For example, the same set of values can be used as for the SAI-based outer label, as those values (e.g., 0 through 255) may all be well below the minimum ESN for all instantiations of the system.

As one example, for the SAI-based outer label, a value of 8 is selected. When a TET sees a 3-byte label value of 0x000008 in the SE outer label, it decrypts the SE packet using its SAI-based Spacelink MAC Address key. For the ESN-base outer label, a value of 9 is selected. When a TET sees a 6-byte label value of 0x020000000009 in the SE outer label, it decrypts the SE packet using its ESN-based Spacelink MAC Address key. The ‘2’ shown as part of the 6-byte label value comes from the locally defined address bit being set. That same bit is also set for SAI-based addresses; but since it is always the same for SAI-based addresses, it can be removed as part of compressing the address from 6 bytes down to 3 bytes.

In some embodiments, specific values for SAI-based and ESN-based outer labels are selected with potential future enhancements in mind. Room can be left (e.g., by skipping over 4 through 7) to allow for more values to be used in the future for inroute bandwidth allocation with those values still being grouped with the existing inroute use values.

Unlike the inroute counter (see below), the outroute counter does not include any terminal-specific information. Therefore, link-layer TRANSEC can be implemented without special handling of the outroute encryption counter. For example, the SE-T counters can be identical to SE (or GSE) counters.

Some embodiments further enhance link-layer TRANSEC by facilitating creation of sets of TETs, each using a different pair of outer labels. This can reduce the inner label filtering load for any particular TET by reducing the number of SE-T packets it needs to process. For example, each TET only performs decryption and filtering of the inner label when the outer label indicates a TET set to which the particular TET belongs. Some such embodiments can use different labels for different TET sets to help ensure segregation of traffic between the TET sets. For example, multiple customers can separately use TRANSEC on a same shared network without risking decryption of each other's traffic by assigning each customer's set of TETs to a separate pair of outer labels.

As noted herein, masking the inner label obscures the identity of the destination TET. Additionally, use of a shared outer label effectively hides the division of bandwidth among the user terminals 110 sharing the label. The total aggregate traffic volume is visible, but the amount of traffic destined to each individual terminal is not. As such, for TE traffic, the SE-T packet format obfuscates both the identity of the receiving user terminal 110 and the manner in which TRANSEC traffic is allocated to individual TETs (i.e., the outroute activity level of individual TETs).

As noted above, the CRO performs scheduling of user traffic to generate SE packets that encapsulate user IP traffic, and these SE packets are packed in a code block. The outroute data sender, a networking entity, can provide a constant traffic rate to the CRO for a TET, along with its modulation and coding rates (MODCODs) and the actual size of the IP packet. In this way, the traffic can be forced to be constant bit rate, or constant sample rate. For example, the outroute sender can append null bytes to IP packets to make each a constant byte size (e.g., 1500 bytes). This can be performed without changing the IP header or any subsequent protocol headers. In some implementations, the protocol between the outroute sender and CRO indicates the adjusted length of the PDU and the actual length of the IP packet using proprietary messaging. For example, the CRO generates SE packets from IP PDUs by encapsulating each IP PDU into one and only one SE packet. The SE header is enhanced to indicate the actual size of the IP PDU and the adjusted size to make the PDU size constant (with NULL bytes) and this information is conveyed on the other side of the encryption boundary (i.e., they are encrypted).

With such an approach, an adversary cannot snoop and find an outroute activity pattern of a TET. Even though the size of IP packets may vary, the size of each SE packet is kept constant. To simulate constant bit-rate traffic for a TET when the incoming traffic is not enough to reach the user terminal's 110 constant service plan rate, the outroute sender may send IP PDUs to the CRO as NULL packets. These packets can be filled with all NULL bytes. For example, the actual length of the PDU can be set to zero by the outroute sender, the CRO can fill the SE packets with all NULL bytes as their payloads, and the encrypted header can indicate to the user terminal 110 that this is a NULL packet.

On the receive side, a TET can decrypt the SE packet to obtain the actual size of every IP PDU encapsulated by the SE packet. The TET removes extra NULL bytes from the PDU, which can be determined as the adjusted length minus the actual length. The IP packet with actual size is sent to the networking layer for further processing. If a SE packet is detected as entirely NULL, there is no further processing on the packet and the packet can be discarded.

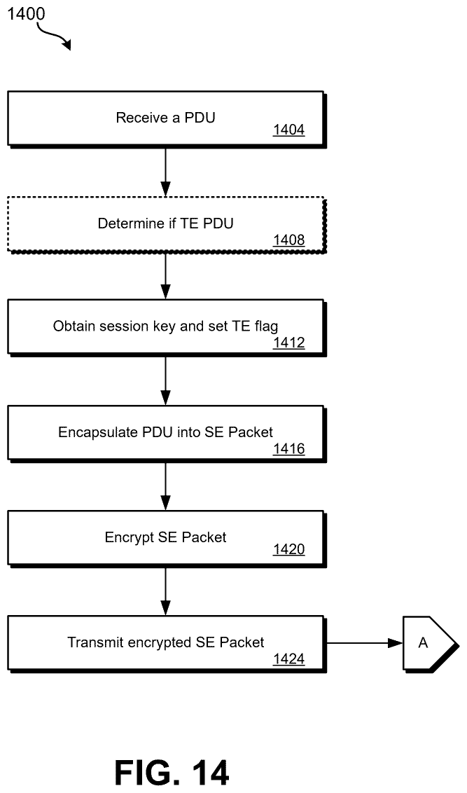

FIG. 14 shows a flow diagram of an illustrative method 1400 for implementing outroute link-layer transmission security (TRANSEC) in a transmit-side of a satellite communication system, according to some embodiments described herein. Embodiments of the method 1400 can be implemented by any suitable ground station, such as those described with reference to FIGS. 1, 2, 3, and 6A.

Embodiments begin at stage 1404 by receiving (e.g., by a ground station) a packet data unit (PDU) associated with TRANSEC traffic being sent to a destination TRANSEC-enabled (TE) terminal. As described herein, the destination TE terminal can be one of a large number of TE terminals. In some embodiments, the destination TE terminal is one of a large number of user terminals including both TE terminals and non-TE terminals.

At stage 1412, embodiments can generate a link-layer session key for the PDU (e.g., by the ground station).

At stage 1416, embodiments can encapsulate the PDU (e.g., by the ground station) into a stream encapsulation (SE) packet according to a TRANSEC stream encapsulation (SE-T) protocol. As described herein, such encapsulation generates the SE packet to include an SE payload and an SE header. The SE payload includes the PDU. The SE header includes both an inner label and an outer label. For PDUs carrying TRANSEC traffic (TE PDUs) the outer label indicates to any of the TE terminals that a true identifier of the destination TE terminal is represented in the inner label.

As described herein, the outer label can be a shared label for some or all TE terminals. In some implementations, each TE terminal is associated with N session keys, where N is an integer greater than 1. For example, each TE terminal is associated with a pair of link-layer session keys. In such implementations, the outer label is selected from a set of N outer labels each indicating a respective one of the N session keys. For example, a first outer label indicates to a receiving TE terminal to use a first of its link-layer session keys, and a second outer label indicates to the receiving TE terminal to use a second of its link-layer session keys. In such implementations, the encryption in stage 1416 (e.g., and later decryption by a receiving TE terminal) is based on whichever of the N session keys is indicated by the selected outer label.

Some embodiments further include, at stage 1408, determining (e.g., by the ground station) upon receipt of the PDU whether the PDU is associated with TRANSEC traffic. If so, a TE flag can be asserted to indicate to a downstream component (e.g., the CRO) that the PDU is a TE PDU. If not, the TE flag can be de-asserted (e.g., or not asserted) to indicate to the downstream component (e.g., the CRO) that the PDU is a non-TE PDU. Embodiments perform the encapsulation in stage 1416 according to the SE-T protocol based on whether the TE flag is asserted. For a PDU indicated (flagged) as a TE PDU, the encapsulating at stage 1416 involves generating the inner label based on the true identifier of the destination TE terminal, and generating the outer label to indicate to any of the plurality of TE terminals that the true identifier of the destination TE terminal is represented in the inner label (i.e., the outer label is not the true identifier). For a PDU indicated as a non-TE PDU (e.g., the TE flag is de-asserted, no TE flag is asserted, etc.), the encapsulating at stage 1416 involves generating the outer label to indicate the true identifier of the destination non-TE terminal. In such cases, some implementations of the SE-T protocol are configured not to generate an inner label (i.e., the inner label is only generated as part of the SE packet format for encapsulated TE PDUs); other implementations of the SE-T protocol are configured to include an inner label field, even though the inner label field is not used by the receiving terminal.

At stage 1420, embodiments can encrypt the SE packet (e.g., by the ground station) based at least on the link-layer session key. As described herein, the encrypting causes the SE payload and the inner label to be encrypted, but leaves the outer label unencrypted.

At stage 1424, embodiments can transmit the encrypted SE packet (e.g., by the ground station) over a satellite outroute to at least the destination TE terminal.

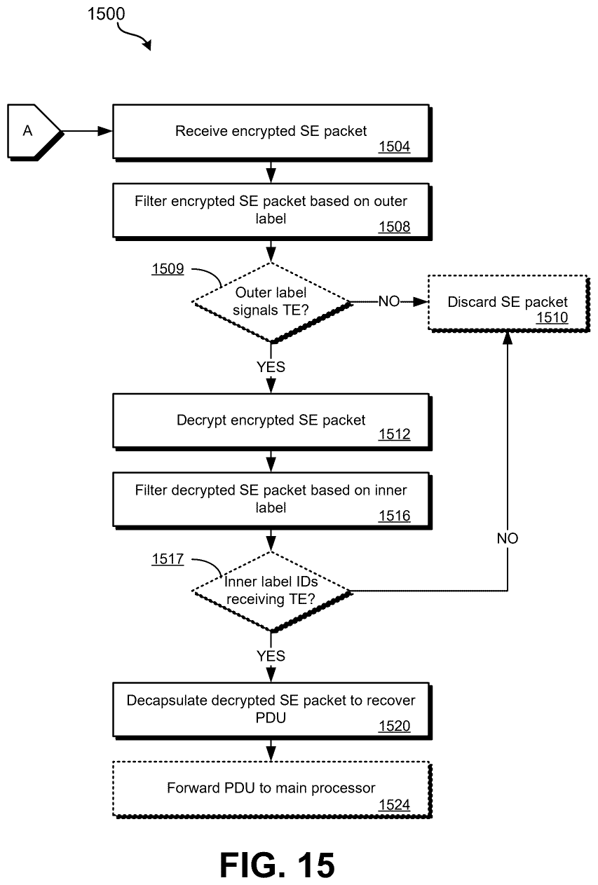

FIG. 15 shows a flow diagram of an illustrative method 1500 for implementing outroute link-layer transmission security (TRANSEC) in a receiving side of a satellite communication system, according to some embodiments described herein. Embodiments of the method 1500 can be implemented by any suitable TE terminal, such as those described with reference to FIGS. 1, 2, 3, and 6B.

Embodiments begin at stage 1504 by receiving an encrypted SE packet by a receiving TE terminal via a satellite outroute. As indicated by page reference ‘A’, it is assumed that the encrypted SE packet was generated according to an implementation of the method 1400 of FIG. 14. For example, the SE packet was encapsulated prior to transmission over the outroute according to a TRANSEC stream encapsulation (SE-T) protocol, so that the SE packet includes an SE payload and an SE header, the SE payload including a PDU destined for a destination TE terminal, and the SE header including both an inner label and an outer label (the outer label indicating to any of the plurality of TE terminals that a true identifier of the destination TE terminal is represented in the inner label).

At stage 1508, embodiments can filter the encrypted SE packet based on the outer label to determine whether the outer label indicates that the true identifier of the destination TE terminal is represented in the inner label.

At stage 1512, embodiments can decrypt the encrypted SE packet responsive to determining that the outer label indicates that the true identifier of the destination TE terminal is represented in the inner label. Some embodiments can obtain a unique session key associated with the receiving TE terminal, wherein the decrypting at stage 1512 is based on at least the unique session key. For example, the decrypting is successful when (only when) the unique session key matches the link-layer session key.

In some embodiments, a determination is made at stage 1509 as to whether the outer label indicates that the true identifier of the destination TE terminal is represented in the inner label, and the decrypting at stage 1512 is only performed responsive to determining that the outer label indicates that the true identifier of the destination TE terminal is represented in the inner label. If the outer label does not provide such an indication, the TE terminal can discard the SE packet at stage 1510 (i.e., this indicates that the TE terminal is receiving an SE packet corresponding to a non-TE PDU).

At stage 1516, embodiments can filter the decrypted SE packet based on the inner label, subsequent to the decrypting, to determine whether the receiving TE terminal is the destination TE terminal.

In some embodiments, a determination is made at stage 1517 as to whether the inner label indicates that the true identifier of the destination TE terminal matches the true identifier of the receiving TE terminal (i.e., that the receiving TE terminal is the destination TE terminal for the SE packet). In such embodiments, the filtering at stage 1516 is only performed responsive to determining that the inner label indicates that the receiving TE terminal is the destination TE terminal for the SE packet. Otherwise, the TE terminal can discard the SE packet at stage 1510 (i.e., this indicates that the TE terminal is receiving an SE packet corresponding to a TE PDU, but destined for a different TE terminal). For example, because the keys are unique to each terminal, any terminal other than the correct destination terminal will use a “wrong” key for decryption. As such, for any terminal that is not the intended receiving TE terminal, the PDU contents will not be decrypted correctly, and the contents will not be visible.

At stage 1520, embodiments can decapsulate the decrypted SE packet to at least partially recover the PDU responsive to determining that the receiving TE terminal is the destination TE terminal.

Some embodiments, at stage 1524, can forward the PDU, subsequent to the decapsulating, to a main processor of the receiving TE terminal.

In some embodiments, the features and methods described herein for secure masking of inroute channel activity with TRANSEC are implemented by computational systems, such as those described with reference to FIGS. 6A and 6B.

### B. Secure Masking of Inroute Channel Activity with TRANSEC

The preceding section discusses link-layer TRANSEC embodiments as applied to the outroute. Embodiments described herein can additionally or alternatively include link-layer TRANSEC as applied to the inroute. Inroute link-layer TRANSEC implementations can include one or more of several features. One such feature adds the ability to encrypt terminal-identifying information, which is conventionally visible (in the clear) in the Inroute Burst Encapsulation (IBE) headers sent across the inroute. Another such feature hides terminal-identifying information, which is conventionally visible (in the clear) in outbound messages sent by the IGM or IBA for inroute bandwidth management purposes. Another such feature introduces per terminal keys for encrypting allocated burst traffic. Another such feature supports sending constant rate (e.g., constant bit-rate or constant sample-rate) traffic from a terminal to hide the terminal's actual rate of traffic.

There are two sources of terminal identification in the standard IBE header: a source address, and information in the Context Information adaptation message used by the IGM to allocate bandwidth to the terminal. These fields are not present in every burst, but interception of these fields would potentially allow an interceptor to identify the bursts of a terminal even without the fields. There are also sources of terminal information that could be used by an interceptor to perform traffic analysis on the terminal, potentially identifying the terminal from its current traffic context. The primary fields which expose this type of information are the Backlog field and the adaptation messages, which include indications as to how much transmit power the terminal currently has.

To protect all this information, some embodiments include a novel TRANSEC enabled IBE protocol, referred to herein as “IBE-T.” The IBE-T protocol (and corresponding packet format) moves potentially terminal-identifying fields to an encrypted portion of the burst. For example, these fields can be moved after the Encryption Counter so that they are encrypted. The IBE-T protocol can be applied to unallocated bursts and/or to allocated bursts, as described below.

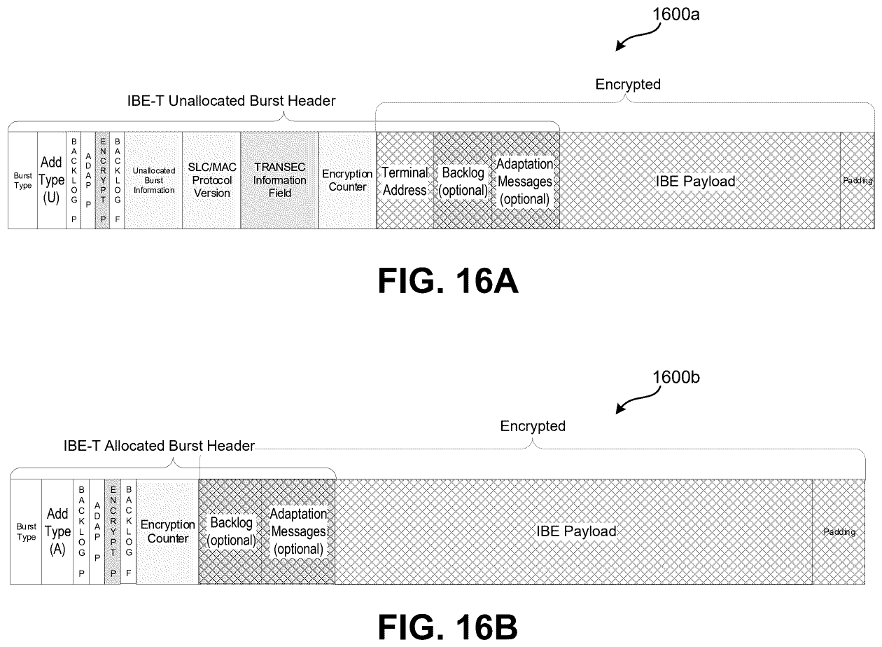

FIGS. 16A and 16B show two illustrative packet formats 1600 for an encrypted burst with TRANSEC, encapsulated according to the IBE-T protocol. In FIG. 16A, the illustrated packet format 1600a is for an encrypted unallocated burst. In FIG. 16B, the illustrated packet format 1600b is for an encrypted allocated burst. From an encryption point of view, the unallocated and allocated bursts are identical. Only the fields included in the IBE-T header differ. In packet format 1600a, the terminal address field, backlog field, and adaptation messages field are all in an encrypted portion of the IBE-T header. In packet format 1600b, there is no terminal address field, but the backlog field, and adaptation messages field are in the encrypted portion of the IBE-T header.

When receiving an unallocated burst, since the IGM does not know which terminal sent the burst, it looks in the burst to find the terminal's address. Thus, embodiments of IBE-T are configured so that the packet itself indicates to the IGM whether the burst was sent using standard IBE packet formatting or modified IBE-T packet formatting. Such embodiments indicate this using a special value in the Address Type (“Add Type”) field. This Address Type value tells the IGM that the terminal's address, the backlog field (e.g., if a Backlog Present bit indicates there is one), and any Adaptation messages (e.g., if an Adaptation Present field indicates that there are any) are encrypted. For example, the Address Type field indicates that it is in an unallocated IBE-T header (e.g., packet format 1600a shows Address Type as “U”, and packet format 1600b shows Address Type as “A”).

In the case of an unallocated burst, then, the source terminal's address is encrypted and therefore cannot be determined by a receiving ground terminal until after burst decryption. This presents a technical concern. Without knowing the source terminal's address, it can be difficult (e.g., conventionally) to derive the encryption counter, obtain decryption keys, etc. For example, decryption may conventionally rely on being able to obtain the source terminal's address, but obtaining the source terminal's address in an IBE-T unallocated burst context may rely on being able to perform decryption.

Conventionally, the terminal's Electronic Serial Number is part of the counter construction for inroute bursts. For allocated bursts, the IGM knows the identity of the terminal because it knows to which terminal it assigned the bandwidth. However, for unallocated bursts, with link-layer TRANSEC enabled, the IGM does not know the identity of the terminal until it decrypts the payload. And the payload cannot be decrypted without a counter. To resolve this issue, for unallocated TRANSEC-Enabled terminals, embodiments assign a “nonce” in place of the ESN to construct the counter. In some implementations, the nonce is a random number. In other implementations, the nonce is any suitable number that is not the ESN, does not potentially conflict with an ESN, and does not conflict with another nonce.

When needed (e.g. for unallocated bursts), TRANSEC is signaled via a new Address Type (shown in FIG. 16A as “U”), which indicates that there is a TRANSEC Information Field (TIF) included instead of an address in the unencrypted portion of the IBE-T header. For example, Address Type “U” can be Address Type=‘3’.

In some implementations, the TIF includes two bits to indicate the actual type and size of the address included in the encrypted part of the IBE-T header. These bits replace the Address Type that would have been sent if the terminal had not been a TE terminal. Such implementations can also include a three-bit Nonce Size field. In some such implementations, if the Nonce Size is non-zero, the TIF includes the Nonce value itself. For example, the Nonce Size to be used is pre-configurable and can range from zero to four.

As noted above, the nonce can be a random number or other non-conflicting number. The reason is that multiple terminals might transmit in the same unallocated burst location. If a fixed value were used, all the terminals would use the same counter to encrypt their bursts. Use of the same counter for multiple AES CTR mode encrypted messages can compromise the encryption. By default, the Nonce Size can be ‘4’ for maximum randomization. In some implementations, the nonce is leading-zero-padded, if necessary.

A TIF may not be used with allocated bursts. The IGM knows to which terminal it assigned the burst and, therefore, it knows the ESN of the terminal and can use that ESN to create the appropriate counter. For example, the packet format 1600b does not include a Terminal Address field at all. In other implementations, a Terminal Address field can be included in the allocated burst IBE-T header, even though the address is not needed by a receiving ground terminal. For example, because the IGM knows the terminal is a TE terminal (e.g., from observing the use of IBE-T for the unallocated burst sent to go active), the native Address Type (e.g., Address Type “A”) can be used in the IBE-T header even though the address has been shifted to the other side of the IBE-T Counter Field (along with any backlog and adaptation messages present).

The use of a per-terminal key is used for unicast traffic sent to a TE terminal. As noted above, each TE terminal can be assigned N (at least two) per-terminal keys for the outroute direction, such as one for its ESN-based Spacelink MAC Address and one for its SAI-based Spacelink MAC Address. One approach in the inroute direction is to provide a third per-terminal key to be used in the inroute direction. Alternatively, each TE terminal can use one of the previously discussed outroute keys also when transmitting on the inroute. In some embodiments, the ESN-based Spacelink MAC Address key is used on the inroute. The IGM is already capable of generating this key.

As noted above, for allocated bursts, an IGM knows which terminal transmitted the burst prior to decryption and, therefore, can easily select the appropriate per terminal key to use to decrypt the burst. However, for unallocated bursts (with the application of the IBE-T protocol) the identity of the sender is encrypted. Trying every possible per terminal key is not practical. Therefore, in some embodiments, terminals use a shared inroute key when transmitting unallocated bursts.

In both the IGM and the terminal, which key to use to encrypt/decrypt a burst can be determined by the nature of the burst allocation. In some implementations, the same shared key is used to send unallocated bursts by the TE terminals and by any non-TE terminals in the network for all of their bursts. In some such implementations, to enhance security when using the shared key, TE terminals can be configured to not send user data in unallocated bursts (with the option enabled by default).

In implementations where a TE terminal uses the ESN-based Spacelink MAC Address it already receives as its per-terminal Inroute Session Key and uses the same shared key it already receives for unallocated bursts, link-layer TRANSEC can be enabled on the inroute without changes to conventional key distribution. For example, terminals already receive this key and the IGM is already provided with the Root Session Key needed to derive this key.

As noted above, and as similar to outroute masking techniques, another way to mask inroute channel activity is to keep the amount of traffic the same across all TETs (or all terminals). For example, some single channel per carrier (SCPC) networks operate with time-division multiplexing (TDM) on the inroute, such that the link is static with no variation in transmission characteristics based on end-user communication. An adversary looking at a satellite transponder with a spectrum analyzer can see a constant RF signal. However, for networks that use time-division multiple access (TDMA) for the return channel network, masking channel activities on inroutes can be challenging.

Typically, a TDMA inroute carrier has a signal when traffic is flowing, and the carrier de-energizes when traffic flow stops. The on-and-off nature of a TDMA inroute is the natural extension of the ability to allocate satellite payload space to remote terminals that have transient channels. Although this characteristics of TDMA inroutes makes TDMA networks much more bandwidth efficient, it enables an adversary to determine various information such as peak periods of activity, identification of unusual or unexpected activity spikes, and identifications of terminals that have remained quiet for a period of time and all of a sudden experience increased traffic volume.

Some embodiments described herein provide a novel quality of service (QoS) schema to mask channel activities by applying constant TDMA allocation to TE terminals. A TE terminal, when identified as such (e.g., by the IBA), gets inroute bandwidth allocation in such a way that it never goes inactive. This can prevent an adversary from traffic engineering by monitoring a user's inroute activities. If there is no user data to send by a TE terminal, embodiments generate dummy bursts with padding.

As described above with reference to initial registration of TE terminals, after a TE terminal is powered on, a single unallocated burst (e.g., an ALOHA burst) is sent (unless communication is cut off for some reason). Subsequently, the IBA can allocate a fresh inroute group and inroute. Although bursts may not have user data (e.g., they are only padding), the IBA can be configured not to deallocate a TE terminal. Rather, the IBA can be configured only to remove an inroute allocation when a TE terminal is powered off, or a link is so bad that nothing traverses the link for at least a predetermined threshold of time (i.e., an extended period). The IBA can be configured not to change the inroute of a TE terminal within an inroute group unless the current inroute does not have enough space to maintain a constant-rate (e.g., constant Mbps or constant Msps) allocation, for example due to usage of more robust MODCOD than the MODCOD at the time of admission, or a new TE terminal arrives which requires inroute re-shuffling among terminals.

To provide constant allocation, embodiments configure the IBA to admit a TE terminal on an inroute which can provide the constant-rate allocation using the terminal's admit-time MODCOD. In cases where such an inroute cannot be found, embodiments can determine and allocate the best possible inroute.

With this type of constant-rate allocation, an adversary snooping for satellite payload RF energies will see a constant pipe for data communication regardless of traffic profiles and applications generating the traffic. As noted above, the constant-rate allocation keeps the inroutes active, regardless of actual traffic flows. Such a constant-rate allocation preserves the efficiencies of a TDMA system while obfuscating actual traffic volumes and/or hints of application types. This can effectively neutralize the risk of using transmission activity as an intelligence gathering mechanism and traffic engineering.

In some embodiments, when the link condition of a TE terminal degrades, the IBA moves the terminal to another inroute within the same inroute group to provide its constant allocation at the degraded MODCOD, if such an inroute is available.

As noted above, embodiments implement constant-rate allocation by applying a novel QoS schema. The new QoS schema is referred to herein as continuous constant-rate (C-CR). The C-CR schema can be implemented as a specially configured version of A-CBR (Adaptive Constant Bit Rate), which generally refers to a schema that dynamically adjusts the transmission rate to accommodate fluctuating data requirements while maintaining a constant average bit rate over time. A-CBR generally combines the predictability of traditional CBR schemes with the efficiency and flexibility of variable bit rate (VBR) schemes. Typically, A-CBR types of schemes have defined minimum and guaranteed bit rates.

With C-CR, the minimum and guaranteed values are defined to be the same, and an inactivity timeout is set to zero (0) so that terminals never time out. Once the terminal goes active, it is allocated a continuous, constant amount of bandwidth forever (or until particular conditions occur to halt C-CR). For example, the IBA only stops allocating bandwidth to the terminal if the terminal stops transmitting bursts for a long time. As long as it keeps transmitting, even if the contents of every burst are padded with null, the IBA keeps giving the terminal bandwidth.

Without TRANSEC, the network has inroute load balancing processes to make sure all inroutes are utilized efficiently. The intention can be to prevent the situation where inroute bandwidths are on the table, but terminals cannot get their service plans. This generally involves continuous shuffling of terminals across inroutes, as terminals'traffic patterns and volume changes along with the changes of terminals'MODCODs due to continuous variations of link conditions. When a terminal is admitted into the network, an inroute is selected where this terminal can grow to some extent while the terminal's traffic volume is increasing, avoiding the need to move the terminal immediately to another inroute when traffic volume starts increasing from the initial demand.

However, in a TRANSEC network, the situation is different. When a TE terminal enters the network, regardless of its initial traffic demand, an inroute is allocated which can provide the constant service plan rate at the terminal's current capable MODCODs. If no such inroute is available, embodiments can determine whether there is any terminal that can be moved from its current inroute to another to make room for the new terminal; at the same time, the terminal or terminals that are moved out from their current inroutes continue to receive their constant service plan rates. If this is not possible (i.e., no terminals can be moved to make room), the new TE terminal can be admitted if a threshold percentage of the service plan rate can be accommodated, assuming a likelihood that the terminal will soon be able to be allocated its full-service plan rate. In case the threshold rate cannot be accommodated, embodiments can reject admission of the TE terminal. This occurrence can indicate that the network sizing is not correct, and the operator needs to take steps to increase the number of inroutes in the network.

Typically, in the TRANSEC network, a TE terminal remains on the same inroute, except in limited cases, such as if a new TE terminal arrives at the network, or if the link margin of an already admitted TE terminal is getting worse and the terminal needs to use more robust MODCOD.

When the terminal is up and not experiencing any drastic issues, it continuously transmits bursts allocated to it. Even if there is no data to transmit, or insufficient data to send without filling with NULL bytes, the IBA continues to allocate bursts without any discontinuity. When the terminal stops sending bursts due to any issues, or the IBA does not receive bursts, the IBA continues to allocate burst bandwidth for a longer time than in the typical non-TRANSEC case, intending that when the issue is resolved, the TE terminal will restart sending constant bursts. This can help to prevent adversaries from detecting activity-inactivity-activity transitions.

When TE and NTE terminals share the same inroute group, embodiments can combine the C-CR scheme for TE terminals with conventional load balancing for NTE terminals. In some hybrid network environments, NTE terminals are configured with QoS types, such as A-CBR (Adaptive Constant Bit Rate), CIR (Committed Information Rate), or TCBE (Traffic Class Based Best Effort). In such environments, embodiments can consider C-CR traffic as highest priority. One result of this is that, when a new NTE terminal is being admitted to the network, the system is configured not to disturb any TE terminals. For example, the system can be restricted from moving any TE terminals from their respective inroutes. It may be possible that the new NTE terminal is rejected, admitted with a reduced rate as compared to its service plan rate, or even not provided with an allocation close to its demand. The NTE terminal, however, will get its minimum guaranteed allocation, and if allocation of minimum guaranteed is not possible, then the admission process for the NTE terminal will be rejected. Another result of prioritizing the C-CR traffic is that, when a new TE terminal comes for admission, the system may be prevented from reducing bandwidth allocations to already admitted NTE terminals, or in the worst-case, pre-empting one or more already admitted NTE terminals, if it is not sufficient to admit a TE terminal with its constant bandwidth requirement after reducing allocation to NTE terminals. In some embodiments, when it is required to reduce rates of NTE terminals or pre-empting NTE terminals, the order in which this is done can start with TCBE NTE terminals, followed by CIR NTE terminals, and finally with A-CBR NTE terminals.

Load balancing of NTE terminals is performed periodically, when a new NTE terminals are admitted, and/or when the link condition varies for NTE terminals. With hybrid TE and NTE terminals sharing inroute/inroute group, embodiments can continue to perform the same load balancing algorithm, as long as: no TE terminals are disturbed, moved from their respective inroute, provided with a reduced rate, or otherwise impacted in QoS; and the amount of bandwidth pool that can be given to NTE terminals are the left over after taking care of constant bit rates allocation of each TE terminal.

As noted above, some embodiments of the C-CR approach are configured to provide constant bit rate. Other embodiments can implement C-CR to mask inroute activities of TE terminals by allocating constant bandwidth (e.g., as constant-hertz-rate, such as constant MHz, or as constant sample-rate, such constant Msps). When a TE terminal enters the network, the IBA allocates number of slots which is equivalent to the configured C-CR QoS. The number of slots allocated to a TE terminal does not vary with the variation of MODCODs of a TE terminal during operation. For example, the TE terminal, based on its current MODCOD, can receive a variable Mbps rate, but a constant Msps rate.

An adversary snooping RF energy of TE terminals would see a constant energy. Unless the adversary performs demodulation and decoding on the signal, it would not know the actual bit rates. Even if they know it, the variation would be exceedingly small when accounting for MODCOD changes; it would be generally impractical or impossible for an adversary to interpret what types of applications the user is running based on such variations. Also, RF layer security or encryption can be applied to further prevent an adversary from demodulating and decoding a signal.

In some embodiments, the features and methods described herein for secure masking of outroute channel activity with TRANSEC are implemented by computational systems, such as those described with reference to FIGS. 6A and 6B.

### V. Link-Layer Address Concealment for TRANSEC-Enabled Terminals

As part of managing the use of inroute bandwidth, the IGM sends messages to the terminals. Some of the messages (e.g., Inroute Set Definition Packets (ISDPs) and Inroute Group Definition Packets (IGDPs)) are intended for reception by all terminals and contain no terminal specific information. Many other message types (e.g., Bandwidth Allocation Packets (BAPs)) are multicast for efficiency to multiple terminals but do include terminal specific information. The visibility of this information can be problematic for a TE terminal because it is easily received by an interceptor and can be used for traffic analysis purposes. For mobile terminals, it also can be used to determine a general location of the terminal, such as in which beam it is currently located.

One possible approach to address this concern is to segregate the inroute bandwidth for TE terminals from the inroute bandwidth for NTE terminals, and then to encrypt the entirety of the various messages related to the TE terminal inroute bandwidth with a shared key. However, introducing such a shared key relies on distributing the key and being able to bootstrap communication before the TE terminal receives it. It also introduces the problem of needing to distribute a new key to all the terminals except one if the one is compromised. These technical hurdles can be overcome, and such an approach can be effective. However, such an approach does not support sharing the same inroute bandwidth between TE and NTE terminals.

Some embodiments described herein provide a different approach as part of link-layer TRANSEC implementation. Such embodiments obscure the identities of TE terminals in outbound messages by masking terminal identities in those messages. The masking approach provides an additional feature: because no shared key is involved, the compromising of any one terminal does not provide access to the identity of any other terminals.

Masking the terminal's identity essentially involves selecting an alternate transient identity to use for the terminal. This involves several considerations. One consideration is that the terminal and the IGM agree on the identity to be used. Another consideration is that the value should not be easily correlated back to the true identity of the terminal. Another consideration is that the value is a valid ID, including that, since it will be sent in bandwidth allocation messages, it avoids overlap with predefined use values (such as the value which indicates an allocation is an ALOHA allocation). Another consideration is that, while SAIs and ESNs are guaranteed to be unique, use of any kind of random or otherwise selected value used as an identifier further involves implementing a collision detection and recovery mechanism. Another consideration is that to avoid traffic correlation, the identity should change over time.

Some implementations can use a cryptographic hash function with the real address and the per-terminal key as inputs. Other implementations can encrypt the address using the per-terminal key. These and other similar types of implementations, however, can pose certain limitations. For example, situations may arise in which such formulaic generation of an identifier results in an unacceptable value, such as one that overlaps predefined use values. Further, these types of implementations tend to result in a single deterministic value, which can conflict with a desire to change the value over time.

Thus, other implementations incorporate random numbers (or quasi-random numbers) into the generation of the alternate transient identity for a terminal. In some such implementations, only the random number is used, and constraints are placed on the random number generation to ensure that it does not overlap with predefined use values. In other such implementations, other generation techniques (e.g., a cryptographic hash) are combined with a random number to avoid limitations. In random number-based implementations, a new random number can be generated or selected whenever it is desired to change the transient identity of a terminal.

The alternate transient identity for a terminal is referred to herein as its “masked terminal identity.” The masked terminal identity is used in place of a System Assigned ID (SAI), which are described above, and can alternatively be referred to as a masked SAI, or mSAIs. Embodiments include two parts to masking terminal identities. One part is selecting a random mSAI to use at the time a terminal goes active. Another part is periodically changing the mSAI while the terminal is already active.

In some embodiments, the range of valid mSAI values is sent to the terminals by the IGM in the ISDP. With respect to changing the mSAI of an active terminal, the terminal and IGM each run independent timers. In the terminal, an mSAI switch timer can control how often an active terminal changes its in-use mSAI value. The duration of the timer to use can be configured in the IGM and can be sent to the terminals in the ISDP. The timeout value can be configured in seconds with a default value (e.g., 10 seconds). In the IGM, the timer can be used to control exactly when to perform the switch of a terminal's in-use mSAI.

In some embodiments, a timer is used to allow the IGM to collect changes for multiple active terminals and change them at the same time. This can frustrate attempts by an outroute interceptor to correlate old and new mSAIs as belonging to the same terminal. The IGM can switch the mSAIs of all the terminals which have completed the setup of an mSAI switch since its last mSAI switch boundary. The process of setting up an mSAI switch can take longer than the IGM's mSAI switch interval and can happen asynchronously with respect to the actual switches taking place. The IGM's mSAI switch timer can be configured in multiples of inroute frames (e.g., multiples of 45 milliseconds) with a default value (e.g., of 32 frames). mSAI switches in the IGM can be executed at an inroute superframe boundary. Some embodiments further use the IGM's mSAI switch time to hold on to previously used mSAI values for a short period of time before freeing them for reuse.

In some implementations, an SAI, and correspondingly an mSAI, is a 24-bit value. Therefore, when a mSAI is needed, a terminal can begin by generating a 24-bit random value constrained to be between a predefined mSAI Range Low Value and a predefined mSAI Range High Value (e.g., inclusive), which can be received from the IGM in the ISDP. The terminal can then check to see if the value is usable. For example, the value is rejected if it is equal to the terminal's real SAI, or the terminal's current mSAI (if the terminal is active). Although such occurrences are highly unlikely, they are possible. In general, mSAIs use the same numbering space as real SAIs. Particularly in environments where TE and NTE terminals do not share the same Inroute Sets, overlap is allowed. In environments where TE and NTE terminals are allowed to share the same Inroute Sets, it may be desirable to prevent overlap.

Some implementations only force the mSAI value to be unique within the context of an inroute set. Typically, the maximum number of terminals in an inroute set is less than 2¹⁴ (e.g., around 16,000 terminals, or potentially much lower, such as 512 terminals), which is many orders of magnitude less than the range 24-bit random numbers. Further, unlike SAIs, mSAIs are transient and can be reused. For these reasons, the likelihood of two terminals trying to use the same mSAI value at the same time is very small. Still, there is a non-zero possibility of concurrent use or other overlap, and the consequences of a collision are a disruption of communication for the colliding terminals.

As noted above, embodiments include a mechanism to detect collisions and avoid the use of the same mSAI value at the same time by multiple terminals is required. This mechanism involves the use of new link-layer messages to support terminals requesting and being granted the use of specific mSAI values. When a request is received, the IGM checks to see if the mSAI is available for use in that inroute set. In such embodiments, an address currently in use by another terminal is tagged as unavailable. mSAI values recently released by terminals, either by going inactive or by requesting a change in mSAI, can also be held as unavailable (e.g., in a pending reuse state) for a short period of time as a safety precaution related to the possible delay of old messages traversing the network.

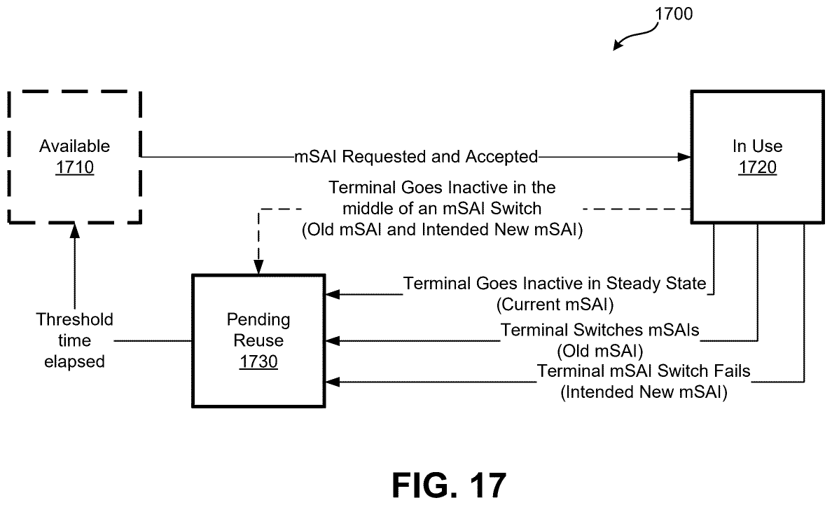

FIG. 17 shows an illustrative representation 1700 of three potential states of a masked system assigned identifier (mSAI) for a terminal, according to some embodiments. As illustrated, the mSAI can be in any of an “available” state 1710, an “in-use” state 1720, or a “pending reuse” state 1730. In a practical implementation, there are likely far too many possible mSAI values to track all mSAIs in the available state 1710. Instead, only those in the in-use state 1720 and pending reuse state 1730 are tracked, and those in the available state 1710 can be implied by not being in either the in-use state 1720 or the pending reuse state 1730.

As illustrated, an mSAI transitions from the available state 1710 to the in-use state 1720 when a request to use the value is received and accepted by the IGM. Also as illustrated, a transition from the in-use state 1720 to the pending reuse state 1730 can occur in several conditions. One condition is when a terminal is switched by the IGM from using one mSAI to using another mSAI. In this case, the old mSAI switches to the pending reuse state 1730. Another condition is when a pending switch to a new mSAI is abandoned due to a message exchange error. In this case, the intended new mSAI can switch to the pending reuse state 1730. Another condition is when a terminal is made inactive by the IGM. The current mSAI can switch to the pending reuse state 1730 unless the terminal goes inactive in the middle of an mSAI switch, in which case, both the old mSAI and the intended new mSAI, if it exists, can switch to the pending reuse state 1730.

At every mSAI switch interval, the IGM checks the list of mSAI values in the pending reuse state 1730 and transitions any mSAI which have been pending for a predetermined threshold amount of time (e.g., two mSAI switch intervals) back to the available state 1710.

The use of masked SAIs can involve introduction of new terminal-to-IGM adaptation messages and new IGM-to-terminal Inroute Command/Acknowledgement Packet (ICAP) messages. The new TRANSEC adaptation and ICAP messages are described below.

Beginning with the TRANSEC adaptation messages, three new types of such messages are described herein: Masked SAI Request (MSR) messages, Masked SAI Change Request (MSCR) messages, and Masked SAI Change Confirmed (MSCC) messages. As described above, the TE terminals can send these adaptation messages (and all other adaptation messages) using the IBE-T protocol. As such, these messages will be encrypted.

An MSR message can be sent to the IGM by a terminal when the terminal wants to go active to propose a particular initial mSAI value for the IGM to use for it while the terminal is active. The MSR message can be is sent in the initial unallocated (e.g., ALOHA) burst used by the terminal to go active. If the proposed mSAI is accepted by the IGM, further action by the IGM may rely on the IGM knowing the real identifiers of the terminal, including the real SAI and real ESN. Since the initial burst is an unallocated burst, the IBE-T header includes the terminal's (encrypted) real SAI. Further, the first time a terminal goes active on an inroute set after a new inroute set selection, it can send a Context Information (CI) adaptation message, which includes the terminal's ESN in the unallocated burst. The IGM can remember the ESN, associating it with the terminal's real SAI. For example, CI messages are very big, and remembering the ESN, along with everything else in the CI, eliminates the need to include the CI message every time the terminal goes active.

If a proposed mSAI is not accepted by the IGM, the IGM does not acknowledge reception of the burst with the MSR in it. This can result in the terminal picking a new proposed mSAI value and trying to go active again. Rules for accepting or rejecting proposed mSAI values are described herein.

MSCR messages and MSCC messages can be used as part of the process for changing an active terminal's masked SAI. MSCR messages and MSCC messages can be sent in allocated bursts and, therefore, the IGM knows which actual terminal is sending the messages, based on knowing to which terminals it allocated the bursts.

A terminal initiates an mSAI change by sending an MSCR message with a new proposed mSAI to the IGM. If the IGM agrees to the new mSAI value (with an MSCRR ICAP message), the terminal confirms that it received the IGM's answer by sending an MSCC message to the IGM. At this point, the terminal starts listening for messages, in particular, Bandwidth Allocation Packets (BAPs), addressed to both its old and its new mSAI values. The terminal does not stop listening to the old mSAI until it finally receives a message sent to its new mSAI. If the IGM rejects the proposed new mSAI, the terminal selects a different proposed new mSAI and sends another MSCR message to the IGM.

As noted above, embodiments include the new TRANSEC adaptation messages described previously, as well as new ICAP messages. Two new ICAP messages are defined: a TRANSEC Terminal Identifier (TTID) message and a masked SAI Change Request Received (MSCRR) message. ICAP messages are not encrypted. Thus, these messages (and any other ICAP messages) sent by the IGM to a TE terminal must not include the terminal's non-masked identifying information. Also, separate ICAP messages are used for each inroute group. Terminals on different inroute groups, whether TE or NTE terminals, do not see each other's ICAP messages.

TTID messages can be sent by the IGM whenever it sends an ICAP message to a TE terminal. For example, a TTID message includes a value which is a SHA-256 hash of the TE terminal's ESN, real SAI, and masked SAI used to send the ICAP message. The TTID can eliminate any possible ambiguity associated with the use of masked SAIs for ICAP messages. However, because the size of the hash value (16 bytes) represents a non-trivial amount of overhead, some implementations only include the TTID messages in an ICAP message when protection against ambiguity is needed. In particular, TTID messages are sent paired with acknowledgement (e.g., ACK, or Enhanced Aloha Acknowledge (EACK)) ICAP messages sent to acknowledge bursts that included an MSR message. If a TE terminal receives an ICAP message when it does not yet have a confirmed mSAI to use (e.g., after sending an MSR), it can compare the hash value in the TTID message to its own hash answer for its ESN, real SAI, and specific mSAI in the ICAP message. If the hash values do not match, the ICAP messages are ignored.

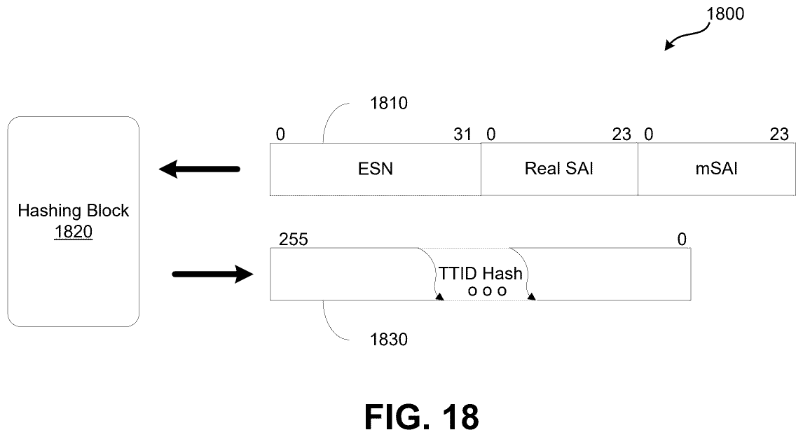

In some implementations, the TE terminal identifier hash algorithm is created based on the ESN, real SAI, and specific mSAI for a terminal. FIG. 18 shows an example data flow 1800 for creating a TE terminal identifier hash, according to some embodiments. As illustrated, three values for the terminal are concatenated together into an input string 1810: the ESN (e.g., 32 bits), the real SAI (e.g., 24 bits), and the mSAI (e.g., 24 bits). Those input values can be converted to network byte order (e.g., according to big endian format), if necessary, before being concatenated. For example, the mSAI is concatenated to the end of the real SAI to create a 48-bit (6-byte) combined value. The combined SAI value can then be concatenated to the end of the ESN to create an 80-bit (10-byte) value that is the input string 1810. The resulting 80-bit input string 1810 can be fed into a hashing block 1820. For example, the hashing block 1820 is implemented to perform a SHA-256 hash on the 80-bit value, resulting in a 256-bit (32-byte value) output string 1830.

When an active TE terminal wants to change its mSAI, the terminal can send an MSCR message to the IGM in an allocated burst. The IGM sends an MSCRR message to the terminal to confirm reception of the message. The MSCRR includes a status code. When the MSCR is received, the IGM checks to see if the proposed new mSAI is available for use by the terminal. If the mSAI is available, the IGM marks it as unavailable for other terminals and sends the MSCRR to the terminal with a status of Change Accepted. In some implementations, however, it does not start using the new mSAI yet. If the proposed new mSAI is not available, the status code in the MSCRR is set to Change Rejected. The latter results in the terminal picking a new proposed new mSAI and retrying. Several algorithms are described below by which a terminal and the IGM can determine whether to agree on the use of an mSAI value.

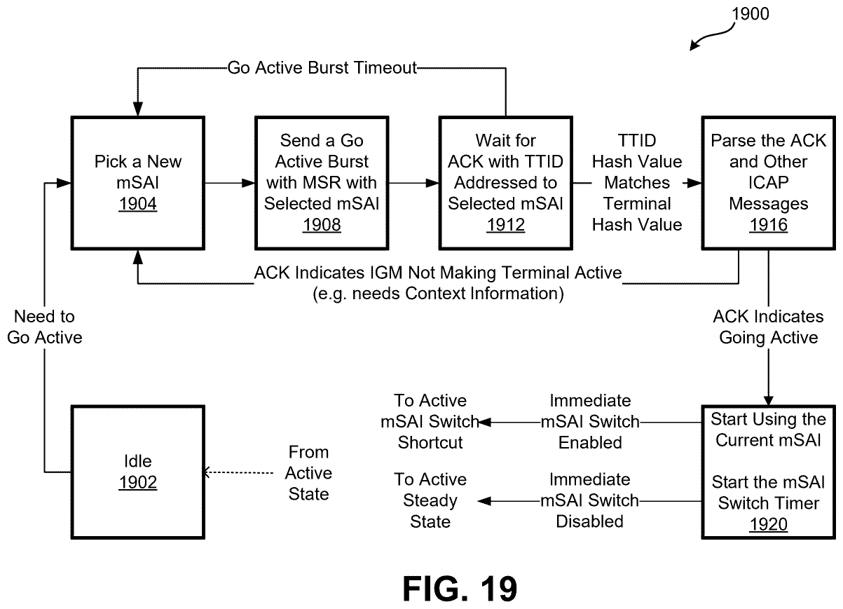

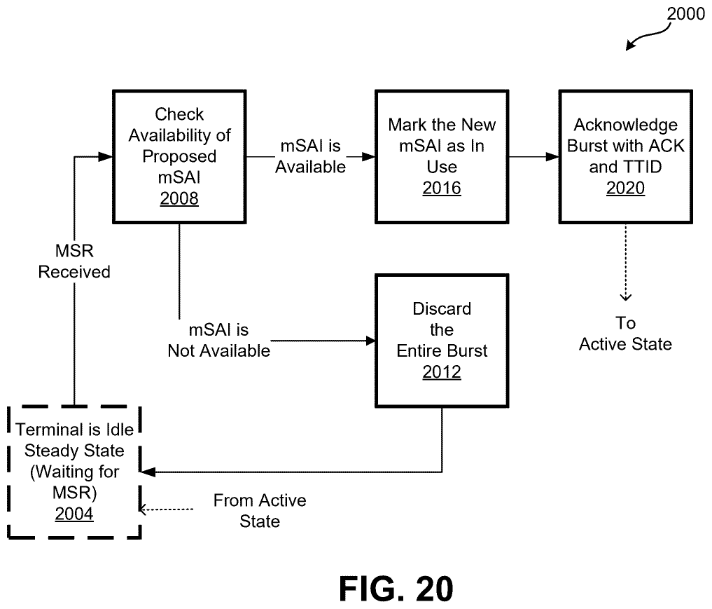

FIG. 19 shows an illustrative flow diagram of a method 1900 performed at a terminal side when a TE terminal is going active while operating with TRANSEC enabled (i.e., after the terminal already has its link-layer session keys), according to some embodiments described herein. FIG. 20 shows an illustrative flow diagram of a method 2000 performed at an inroute group manager (IGM) side, corresponding to the terminal-side method 1900 of FIG. 19, according to some embodiments described herein. The two methods 1900 and 2000 are described in parallel.

The methods 1900 and 2000 assume a TE terminal is presently in an idle state. This is indicated by stage 1902 of FIG. 19. Correspondingly, stage 2004 of FIG. 20 shows the IGM in a state where it is considering this TE terminal as idle. At some point, the TE terminal determines that it needs to go active, triggering the terminal, at stage 1904 of FIG. 19, to randomly selects a valid mSAI value.

At stage 1908 of FIG. 19, the terminal attempts to go active by sending an unallocated burst with the selected mSAI value. For example, the burst is a TDMA Aloha burst. As described herein, the burst is sent using an IBE-T protocol, and the IBE-T header can include a TRANSEC Information Field (TIF) with a nonce. The size of the nonce is controlled via (advanced) configuration (e.g., defaulting to four bytes). The nonce is used in place of the terminal's ESN when constructing the crypto counter for the burst. The presence of the TIF is indicated in the IBE Base Header's Address Type field. In addition to the usual fields the terminal sends when going active (e.g., backlog and, when needed, Content Information), the terminal includes an MSR adaptation message with its proposed mSAI. The TIF is in the clear, but all the rest of the information is placed after the Encryption Counter field and is encrypted with the terminal's shared ISK.

At stage 1912 of FIG. 19, the terminal starts a response timer to wait for the IGM to acknowledge successful reception of the MSR message. Specifically, the terminal is looking for an ICAP with an ACK (or EACK) paired with a TE terminal identifier (TTID) sent to its proposed mSAI, where the hash in the TTID matches the terminal's own hash answer. The terminal ignores any messages it might see sent to the mSAI, except for the ACK.

If the response timer expires before the terminal receives an ACK, the terminal can return to stage 1904.

Meanwhile, the IGM is waiting at stage 2004 of FIG. 20 for an MSR message from a terminal that is presently being considered as in an idle steady state. Upon receipt of the MSR message (sent in stage 1908 of FIG. 19), the IGM can proceed to stage 2008 of FIG. 20. The IGM sees that the burst is using the IBE-T format with a nonce in the TIF. Therefore, it can use the nonce to construct the crypto counter and can use the shared ISK to decrypt the burst. Other burst header fields can be processed after decryption. Then, still at stage 2008 of FIG. 20, the IGM extracts the proposed mSAI from the MSR and checks to see if it is available for use within this inroute set.

If the proposed mSAI is not available, the IGM discards the go active request and does not respond to the burst. The IGM can return to stage 2004 of FIG. 20 to wait for a next burst. This can further result in the terminal timing out, as illustrated by no ACK being received at stage 1912 of FIG. 19 and the terminal returning to stage 1904 of FIG. 19.

If the proposed mSAI is available, the IGM can mark the new mSAI as in use at stage 2016 of FIG. 20. For example, the new mSAI switches from an available state 1710 to an in-use state 1720. At stage 1920 of FIG. 20, the IGM can respond to the burst with ICAP messages, including a set of messages addressed to the mSAI. The set of messages includes an ACK (e.g., EACK), an Inroute Group Change (i.e., a message to tell the terminal on which TDMA inroute group the terminal will first receive “active” bandwidth), and a TTID.

Returning to stage 1912 of FIG. 19, the terminal receives the ICAP messages, including the ACK, Inroute Group Change, and TTID. The terminal can parse the messages to find a set of messages addressed to the mSAI it proposed. Because it is a TE terminal, if there is no TTID message included, the set of messages is ignored. If there is a TTID message, the terminal compares the hash value it contains to its own hash answer for its ESN, real SAI, and proposed mSAI to make sure the other messages are really intended for itself (as opposed to some other terminal which just happened to select the same proposed mSAI).

If the hash values do not match, the terminal ignores the set of ICAP messages. If the hash values do match, the terminal can proceed to stage 1916 of FIG. 19, where the terminal processes the ACK and other ICAP messages. In some cases, the ACK may indicate that the IGM is not making the terminal active (e.g., the IGM needs context information). In such cases, the terminal can return to stage 1904 of FIG. 19. If the ACK does indicate that the IGM is making the terminal go active, the terminal can become active, accordingly.

In the case that the terminal goes active, the terminal can proceed to stage 1920 of FIG. 19, where the terminal starts to use the new mSAI. In some implementations, the terminal initiates an mSAI change timer. The duration of the timer can be advertised by the IGM in the ISDP. In other implementations (e.g., if optionally enabled), the terminal initiates an immediate masked SAI change. For example, initiating an immediate masked SAI change can be implemented by setting the mSAI timer to zero, or by otherwise indicating as if the timeout has already expired. The option can be advanced configurable.

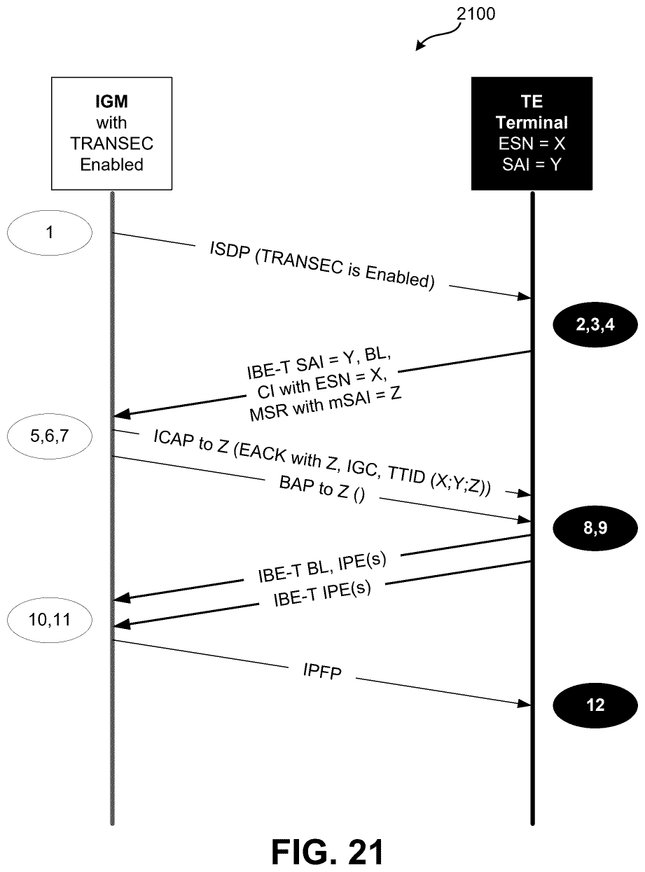

FIG. 21 shows a ladder diagram 2100 representing a TE terminal successfully going active with a new mSAI on a first attempt. In the represented scenario, the TE terminal is going active with a randomly selected mSAI value that does not collide with any existing mSAI values. As noted herein, mSAI collisions are unlikely and should be rare. As such, the scenario represented in FIG. 21 can be assumed as the typical (probable) scenario. The ladder diagram 2100 illustrates message exchanges between an IGM with TRANSEC enabled and a TE terminal. As illustrated, the TE terminal has some ESN represented as ‘X’ and some SAI represented as ‘Y’. Numbers in ovals represent stage numbers (e.g., ‘1’ represents stage 1) of the ladder diagram 2100.

Beginning at stage 1, since the IGM supports TRANSEC, and TRANSEC is enabled for the inroute set, the IGM indicates to the TE terminal that TRANSEC is enabled in the ISDP. At stage 2, the TE Terminal sees that TRANSEC is enabled in the inroute set and selects it for use. A TE terminal will only use an inroute set if the inroute set has TRANSEC enabled.

At stage 3, the TE Terminal determines it needs to go active and sends a TDMA unallocated (e.g., ALOHA) burst using the IBE-T format with a TIF. As described herein, the burst includes unencrypted and encrypted information. The unencrypted information can include the Address Type set to IBE-T indicating the inclusion of a TIF, and the TIF including a nonce for use instead of the ESN to derive the crypto counter. The encrypted information is encrypted with the shared ISK using the nonce and includes the actual SAI of the TE terminal as its real address, a backlog field, a Context Information adaptation message that includes the real ESN, and a MSR adaptation message with a randomly selected proposed mSAI value (represented as ‘Z’). Any data in the unallocated burst can also be encrypted with the shared ISK. However, since the shared ISK is being used, the TE terminal may (optionally) be configured to only send padding in the data portion of the burst. In some implementations, by default, no user data is allowed.

At stage 4, the TE terminal begins looking for an acknowledgement message addressed to its proposed mSAI (‘Z’). The ACK message specifically expected can be an EACK message, which has been indicated as belonging to the TE terminal by being paired with a TTID message.

At stage 5, since the burst is an unallocated burst, it is decrypted by the IGM with the shared ISK. Because the burst format is IBE-T, the IGM can use the nonce in the TIF for the crypto counter and can look for the real address (e.g., and other information) beyond the Counter field after decryption.

At stage 6, the IGM can check to see that the requested mSAI (‘Z’) is available. The illustrated scenario assumes that the requested mSAI is available. As such, the IGM makes the TE terminal active and ACKs the burst with a set of ICAP messages for mSAI ‘Z’ included in the packet. The messages include an EACK, an IGC and, because TRANSEC is enabled for the inroute set, a TTID message. The TTID message contains a hash of the ESN, SAI, and mSAI (i.e., ‘X’, ‘Y’, and ‘Z’). At stage 7, the IGM can start to allocate bandwidth (bandwidth allocation parts, BAP) to the TE terminal using mSAI ‘Z’.

At stage 8, the TE Terminal receives the ICAP messages addressed to mSAI ‘Z’. The TE terminal compares the TTID message hash value to its own hash answer. Because they match, the terminal accepts the IGC and EACK as actually belonging to itself, goes active using mSAI ‘Z’ as its address, and starts listening for bandwidth allocations to mSAI ‘Z’.

At stage 9, the TE terminal sends bursts using the IBE-T format when it is allocated bandwidth. It uses its per-terminal ESN-based session key to encrypt the bursts with its ESN as part of the crypto counter.

At stage 10, the IGM (since the bursts are allocated bursts) already knows which terminal sent the bursts. It uses the TE terminal's ESN-based session key to decrypt the bursts because the terminal is a TE terminal, using the terminal's stored ESN as part of the crypto counter.

At stage 11, the IGM acknowledges the bursts with Inroute Packet Fragment Protocol (IPFP) messages. At stage 12, the TE terminal processes the IPFPs.

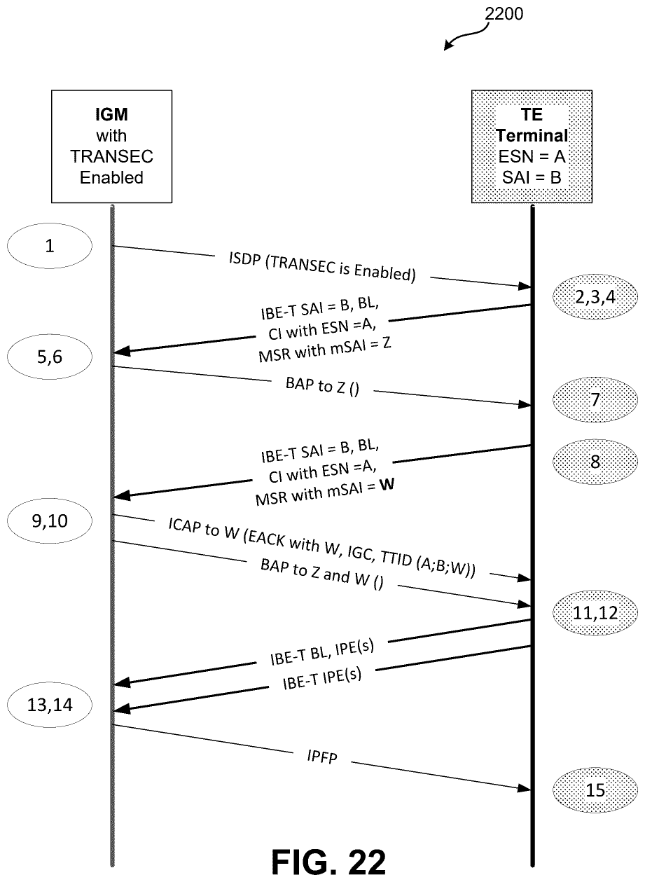

FIG. 22 shows a ladder diagram 2200 representing a TE terminal first unsuccessfully going active due to a mSAI collision and subsequently successfully going active after selecting a different non-colliding mSAI. The ladder diagram 2200 illustrates message exchanges between an IGM with TRANSEC enabled and a TE terminal. As illustrated, the TE terminal has some ESN represented as ‘A’ and some SAI represented as ‘B’. Numbers in ovals represent stage numbers (e.g., ‘1’ represents stage 1) of the ladder diagram 2200.

Beginning at stage 1, since the IGM supports TRANSEC, and TRANSEC is enabled for the inroute set, the IGM indicates to the TE terminal that TRANSEC is enabled in the ISDP. At stage 2, the TE Terminal sees that TRANSEC is enabled in the inroute set and selects it for use. A TE terminal will only use an inroute set if the inroute set has TRANSEC enabled.

At stage 3, the TE Terminal determines it needs to go active and sends a TDMA unallocated (e.g., ALOHA) burst using the IBE-T format with a TIF. As described herein, the burst includes unencrypted and encrypted information. The unencrypted information can include the Address Type set to IBE-T indicating the inclusion of a TIF, and the TIF including a nonce for use instead of the ESN to derive the crypto counter. The encrypted information is encrypted with the shared ISK using the nonce and includes the actual SAI of the TE terminal as its real address, a backlog field, a Context Information adaptation message that includes the real ESN, and a MSR adaptation message with a randomly selected proposed mSAI value (represented as ‘Z’). Any data in the unallocated burst can also be encrypted with the shared ISK. However, since the shared ISK is being used, the TE terminal may (optionally) be configured to only send padding in the data portion of the burst. In some implementations, by default, no user data is allowed.

At stage 4, the TE terminal begins looking for an acknowledgement message addressed to its proposed mSAI (‘Z’). The ACK message specifically expected can be an EACK message, which has been indicated as belonging to the TE terminal by being paired with a TTID message.

At stage 5, since the burst is an unallocated burst, it is decrypted by the IGM with the shared ISK. Because the burst format is IBE-T, the IGM can use the nonce in the TIF for the crypto counter and can look for the real address (e.g., and other information) beyond the Counter field after decryption.

At stage 6, the IGM can check to see that the requested mSAI (‘Z’) is available. The illustrated scenario assumes that the requested mSAI is not available. As such, the IGM discards the message and does not send an ACK message back to the TE terminal.

At stage 7, the TE terminal has not received an ACK for its proposed mSAI. As such, the TE terminal ignores any bandwidth allocation messages it might see for mSAI ‘Z’. It can also (not shown) ignore any ICAP messages it might see for mSAI ‘Z’ that do not have a TTID message indicating that the ICAP messages are really for itself. At stage 8, after some time has elapsed and no ACK has been received, the TE terminal picks a new candidate mSAI (represented as ‘W’) (and TIF nonce) and retries the burst.

At stage 9, the IGM decrypts the new burst and checks to see that the requested mSAI (‘W’) is available. The illustrated scenario assumes that the second requested mSAI (‘W’) is available. As such, the IGM makes the TE terminal active and ACKs the burst with a set of ICAP messages for mSAI ‘W’ included in the packet. The messages include an EACK, an IGC and, because TRANSEC is enabled for the inroute set, a TTID message. The TTID message contains a hash of the ESN, SAI, and mSAI (i.e., ‘X’, ‘Y’, and ‘W’). At stage 10, the IGM can start to allocate bandwidth (bandwidth allocation parts, BAP) to the TE terminal using mSAI ‘W’.

At stage 11, the TE terminal receives the ICAP messages addressed to mSAI ‘W’. The TE terminal compares the TTID message hash value to its own hash answer. Because they match, the terminal accepts the IGC and EACK as actually belonging to itself, goes active using mSAI ‘W’ as its address, and starts listening for bandwidth allocations to mSAI ‘W’. At stage 12, the TE terminal sends bursts using the IBE-T format when it is allocated bandwidth. It uses its per-terminal ESN-based session key to encrypt the bursts with its ESN as part of the crypto counter.

At stage 13, the IGM (since the bursts are allocated bursts) already knows which terminal sent the bursts. It uses the TE terminal's ESN-based session key to decrypt the bursts because the terminal is a TE terminal, using the terminal's stored ESN as part of the crypto counter. At stage 14, the IGM acknowledges the bursts with IPFP messages. At stage 15, the TE terminal processes the IPFPs.

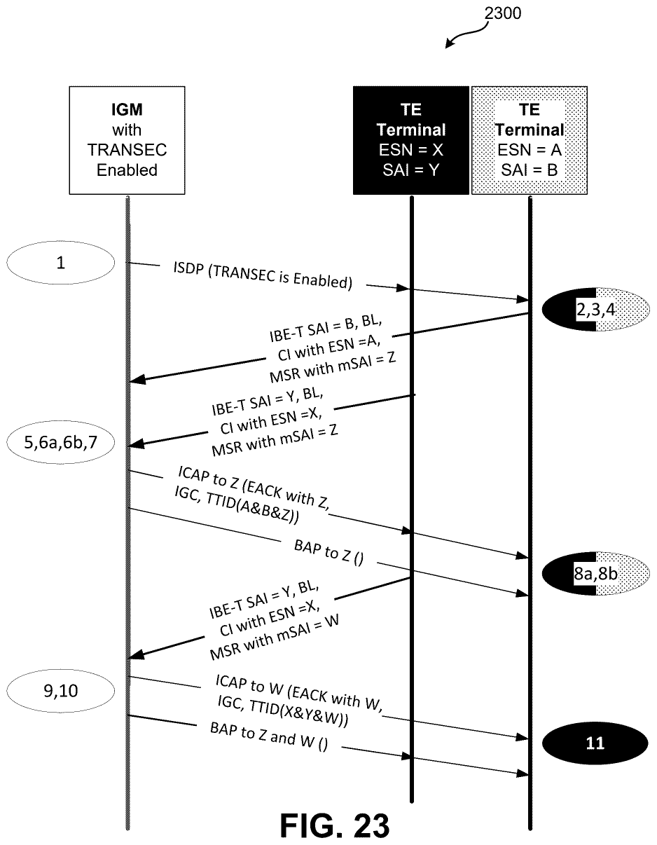

FIG. 23 shows a ladder diagram 2300 representing two TE terminals attempting to go active at the same time using the same randomly selected masked SAI value. Simultaneous attempts to use the same mSAI can happen when going from idle to active, or when changing mSAIs. The illustrated approach allows whichever terminal's request gets processed first to be assigned the requested mSAI value, while the other terminal(s) requesting the same value at the same time are forced to reselect a new mSAI value. Such simultaneous mSAI collisions are assumed practically to be extremely rare, but still possible.

The ladder diagram 2300 illustrates message exchanges between an IGM with TRANSEC enabled and two TE terminals. As illustrated, a first TE terminal has some ESN represented as ‘X’ and some SAI represented as ‘Y’ (e.g., as in FIG. 21), and another TE terminal has some ESN represented as ‘A’ and some SAI represented as ‘B’ (e.g., as in FIG. 22). Numbers in ovals represent stage numbers (e.g., ‘1’ represents stage 1) of the ladder diagram 2300.

Beginning at stage 1, since the IGM supports TRANSEC, and TRANSEC is enabled for the inroute set, the IGM indicates to the TE terminals that TRANSEC is enabled in the ISDP. At stage 2, the TE Terminals see that TRANSEC is enabled in the inroute set and both select it for use.

At stage 3, each TE Terminal determines it needs to go active and sends a TDMA unallocated (e.g., ALOHA) burst using the IBE-T format with a TIF. As described herein, the burst includes unencrypted and encrypted information. The unencrypted information can include the Address Type set to IBE-T indicating the inclusion of a TIF, and the TIF including a nonce for use instead of the ESN to derive the crypto counter. The encrypted information is encrypted with the shared ISK using the nonce and includes the actual SAI of the TE terminal as its real address, a backlog field, a Context Information adaptation message that includes the real ESN, and a MSR adaptation message with a randomly selected proposed mSAI value. In this illustrated scenario, both TE terminals have randomly selected the same mSAI value (represented as ‘Z’). At stage 4, each TE terminal begins looking for an acknowledgement message addressed to the proposed mSAI (‘Z’).

At stage 5, since the bursts are unallocated bursts, they are decrypted by the IGM with the shared ISK using the IBE-T nonce values.

At stage 6, the bursts are now processed by the IGM in the order in whatever order they reach the relevant processing blocks, such as in the order in which they are received. Because each burst is separately processed, stage 6 is represented as stages 6a and 6b. At stage 6a, the burst from TE terminal with ESN ‘A’ is processed. The IGM checks to see that the requested mSAI (‘Z’) is available, which it is assumed to be at this point. The IGM makes the TE terminal active and ACKs the burst with ICAP messages addressed to mSAI ‘Z’, including an EACK, an IGC, and a TTID message. At stage 6b, the burst from TE terminal with ESN ‘X’ is processed. The IGM checks to see that the requested mSAI (‘Z’) is available, which it no longer is (as it was already assigned to TE terminal with ESN ‘A’). The IGM discards the message, accordingly, and does not send an ACK to the TE terminal.

Now, communications with the TE terminal with ESN ‘A’ can proceed substantially according to FIG. 21, and communications with the TE terminal with ESN ‘X’ can proceed substantially according to FIG. 22. For example, at stage 7, the IGM starts allocating bandwidth to the TE terminal with ESN ‘A’ using mSAI ‘Z’. At stages 8a and 8b, both TE terminals receive the ICAP addressed to mSAI ‘Z’. At stage 8a, the TE terminal with ESN ‘A’ compares the TTID message hash value to its own hash answer, finds that they match, and accepts the IGC and EACK as actually belonging to itself. Accordingly, the TE terminal goes active using mSAI ‘Z’ as its address and starts listening for bandwidth allocations to mSAI ‘Z’. At stage 8b, in contrast, the TE terminal with ESN ‘X’ compares the TTID message hash value to its own hash answer, finds that they do not match, and knows the message is not for itself. The TE terminal discards all of the ICAP messages, accordingly.

In some implementations, because the TE terminal with ESN ‘X’ sees that the selected mSAI has been sent to another terminal (the TTID hash value did not match) it can infer that its mSAI selection was rejected. The TE terminal with ESN ‘X’ can then pick a new candidate mSAI (‘W’) and retry. In other implementations, the TE terminal with ESN ‘X’ can wait for the ACK timeout before retrying.

At stage 9, the IGM decrypts the new burst and checks to see that the requested mSAI (‘W’) is available. The illustrated scenario assumes that the second requested mSAI (‘W’) is available for the TE terminal with ESN ‘X’. As such, the IGM makes that TE terminal active and ACKs the burst with a set of ICAP messages for mSAI ‘W’ included in the packet. The messages include an EACK, an IGC and, because TRANSEC is enabled for the inroute set, a TTID message. The TTID message contains a hash of the ESN, SAI, and mSAI (i.e., ‘X’, ‘Y’, and ‘W’).

At stage 10, the IGM can start to allocate bandwidth to the TE terminal with ESN ‘X’ using mSAI ‘W’, while continuing to allocate bandwidth to the TE terminal with ESN ‘A’ using mSAI ‘Z’. At stage 11, the TE terminal with ESN ‘X’ receives the ICAP messages addressed to mSAI ‘W’. The TE terminal compares the TTID message hash value to its own hash answer, finds that they match, and terminal accepts the IGC and EACK as actually belonging to itself. The TE terminal also goes active using mSAI ‘W’ as its address and starts listening for bandwidth allocations to mSAI ‘W’.

This scenario illustrates that sending an explicit collision notification (instead of just letting the terminal timeout and retry) complicates error handling. An ICAP can only contain a single set of messages for a given address. As such, sending messages to two different terminals which are (temporarily) using the same SAI requires either forcing the messages to be sent in separate ICAPs or using a complicated TTID message structure in order to tie some messages to one terminal and other messages to the other terminal in the same ICAP. Neither option is desirable, especially because the rejection can be inferred from the combination of EACK and TTID addressed to another terminal.

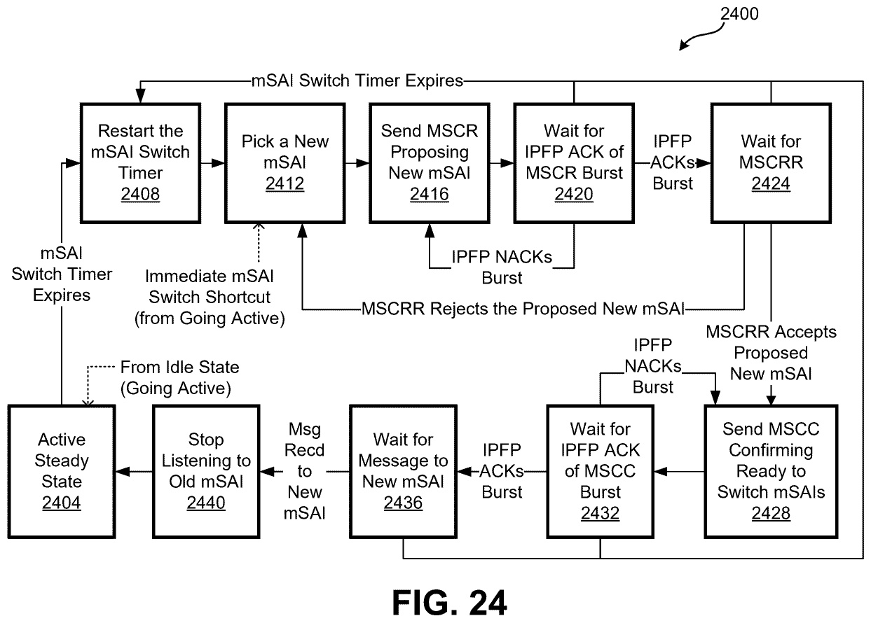

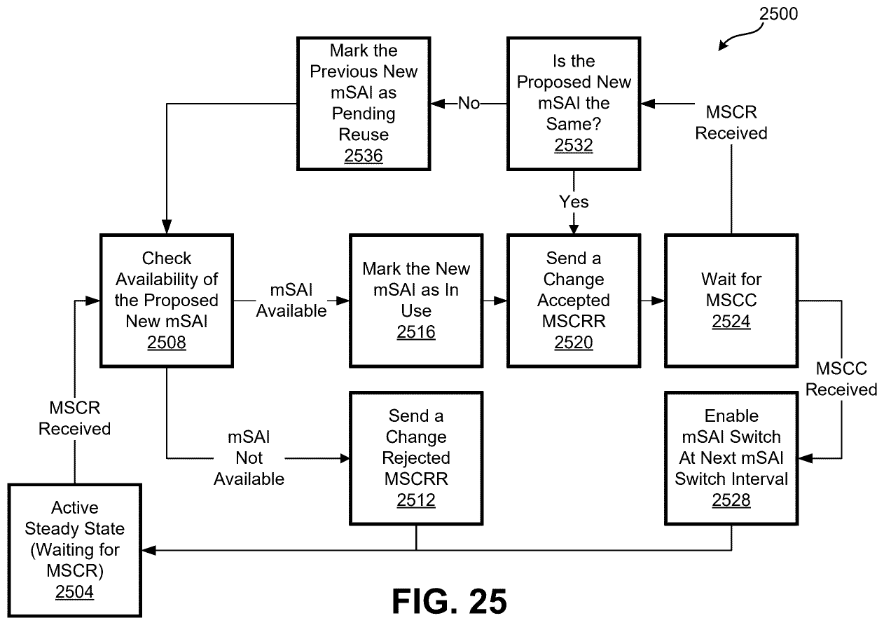

FIG. 24 shows an illustrative flow diagram of a method 2400 performed at a terminal side when a TE terminal is changing its mSAI while active, according to some embodiments described herein. FIG. 25 shows an illustrative flow diagram of a method 2500 performed at an inroute group manager (IGM) side, corresponding to the terminal-side method 2400 of FIG. 24, according to some embodiments described herein. The two methods 2400 and 2500 are described in parallel.

The methods 2400 and 2500 assume a TE terminal is presently in an active state. This is indicated by stage 2404 of FIG. 24. Correspondingly, stage 2504 of FIG. 25 shows the IGM in a state where it is considering this TE terminal as presently active. At some point, the TE terminal determines that it needs to switch its mSAI (e.g., an mSAI switch timer expires or times out), triggering the terminal to move to stage 2408 of FIG. 24.

At stage 2408 of FIG. 24, upon the mSAI switch timeout expiring, the TE terminal can immediately restart the timer. This reduces the likelihood of every terminal initiating a mSAI change at the same time. At stage 2412 of FIG. 24, the TE terminal can randomly select a new valid mSAI value. At the next allocated transmit opportunity, at stage 2416 of FIG. 24, the TE terminal can send a mSAI Change Request (MSCR) adaptation message with the proposed new mSAI value to the IGM.

At stage 2420 of FIG. 24, the TE terminal waits for in IPFP ACK message acknowledging that the MSCR burst was received by the IGM. Three things can happen. One possibility (optionally) is that nothing happens for some time until the mSAI switch timer expires. In such a case, the TE terminal can return to stage 2408 to restart the mSAI switch timer. Another possibility is that the TE terminal does not receive an ACK (or received a NACK) to the burst which contained the MSCR when it receives the IPFP for that inroute frame. In such a case, the TE terminal can return to stage 2416 and resend the MSCR with the same proposed new mSAI.

A third possibility is that the burst is ACKed. In such a case, the TE terminal can proceed to stage 2424 of FIG. 24, in which the TE terminal waits for an MSCRR response from the IGM. Here, again, three things can happen. A first possibility is that nothing happens for some time until the mSAI switch timer expires, and the TE terminal can return to stage 2408 to restart the mSAI switch timer. A second possibility is that the TE terminal receives an MSCRR message indicating a rejection of the proposed new mSAI. In such a case, the TE terminal can return to stage 2412 and can select a new mSAI to propose. A third possibility is that the TE terminal receives an MSCRR message indicating an acceptance of the proposed new mSAI. In such a case, the TE terminal can proceed to stage 2428 of FIG. 24.

In the meantime, turning to FIG. 25, the IGM is waiting at stage 2504 of FIG. 25 for an MSCR. Upon receipt, the IGM moves to stage 2508 of FIG. 25, in which it extracts the proposed new mSAI value and checks to see if it is available. In either case, the IGM responds to the request with a mSAI Change Request Received (MSCRR) ICAP message. The MSCRR includes a status code and is sent to the TE terminal's current mSAI.

In the case that the proposed new mSAI is not available, the IGM proceeds to stage 2512 of FIG. 25, in which it rejects the proposed changed by setting the MSCRR status to Change Rejected. The IGM expects the terminal to pick a new proposed new mSAI and to retry, but the IGM may not do anything special to force that, and/or it may not do anything if a new mSAI is never proposed. The IGM can return to stage 2504 to wait for a next MSCR message.

In the case that the proposed new mSAI is available, the IGM can proceed to stage 2516 of FIG. 25, in which it accepts the proposed change by setting the MSCRR status to Change Accepted. The accepted proposed new mSAI can be switched to the in-use state 1720 (from the available state 1710, as described in FIG. 17). At stage 2520 of FIG. 25, the IGM can send the MSCRR message indicating acceptance of the proposed mSAI change.

In some embodiments, the IGM does not actually perform the switch of the mSAI for the TE terminal yet. Instead, it can wait for confirmation from the TE terminal (in the form of an MSCC adaptation message) that the TE terminal is ready for the change. For example, as illustrated, the IGM can wait for the MSCC message at stage 2524 of FIG. 25.

In some cases, the IGM never receives an MSCC message (e.g., indicating that the TE terminal did not confirm the mSAI switch for whatever reason). In some embodiments, in such a case, the IGM can wait until the next time it receives an MSCR from that TE terminal at stage 2532 of FIG. 25. This new MSCR message will include a proposed new mSAI, and the proposed new mSAI will either have the same value as the previously proposed mSAI (which was not confirmed), or it will propose a new mSAI value. If the new MSCR message proposed the same mSAI as before, the IGM can return to stage 2520 and can try again to send a MSCRR message indicating that the proposed change is accepted. If the new MSCR message proposed a different (new) mSAI from the previously requested mSAI, the previously requested mSAI can be switched to the pending reuse state 1730 at stage 2536 of FIG. 25, and the IGM can return to stage 2508 to check availability of the newly proposed mSAI.

Returning to stage 2424 of FIG. 24, the TE terminal can receive the MSCRR sent in stage 2520 of FIG. 25 by the IGM. When the TE terminal receives the MSCRR, it checks the Status Code to determine whether the proposed mSAI change was accepted or rejected. As noted above, if rejected, the TE terminal can return to stage 2412 to select a new mSAI. If accepted, at stage 2428 of FIG. 24, at the next allocated transmit opportunity, the TE terminal can send a MSCC adaptation message to the IGM to indicate that it is ready for the mSAI switch (as noted above, the IGM is waiting to receive this message at stage 2524 of FIG. 25). The MSCC indicates to the IGM that it is ready to make the switch to the proposed new mSAI.

At stage 2432 of FIG. 24, the TE terminal can wait for an IPFP ACK to the burst which contained the MSCC when it receives the IPFP for that inroute frame. If the TE terminal does not receive an ACK (or receives a NACK) to the burst which contained the MSCC when it receives the IPFP for that inroute frame, the TE terminal can return to stage 2428 to resend the MSCC. If the TE terminal does receive an ACK to the burst which contained the MSCC when it receives the IPFP for that inroute frame, the TE terminal can start listening to messages (e.g., BAPs) sent to both its old and new mSAI values.

Returning again to FIG. 25, assuming the IGM receives the MSCC at stage 2524, the IGM can proceed to stage 2528 of FIG. 25, in which it can schedule the switch of the mSAI for the TE terminal. As described herein, some implementations do not immediately make the switch to the new mSAI. For example, making the switch at the time the MSCC is received can be detected by an outroute interceptor and can easily be correlated to stopping use of the old mSAI and starting use of the new mSAI at the same time, which can defeat the purpose of changing the mSAI. Instead, such implementations can defer the actual change of mSAI until a next mSAI switch interval. In this way, many terminals will change their mSAIs at the same, making it very difficult to correlate the old to new mSAI switch for any particular TE terminal.

At the next mSAI switch boundary, the IGM stops using the old mSAIs and starts using the new mSAIs for every terminal that successfully completed stage 2528 since the last mSAI switch boundary. In some embodiments, all the old mSAIs are transitioned to the pending reuse state 1730.

Returning again to FIG. 24, at stage 2436 of FIG. 24, the TE terminal will either begin to receive messages on its new mSAI, or enough time will elapse that the mSAI switch timer will expire. If the mSAI switch timer expires, the TE terminal can return to stage 2408 to restart the timer and pick a new mSAI at stage 2412. If the TE terminal begins receiving messages on its new mSAI, it can stop listening to the previous mSAI at stage 2440 of FIG. 24. As illustrated, the TE terminal can effectively return to its active steady state in stage 2404 with its new mSAI.

There is a possibility at any time that a TE terminal will go inactive. In such a case, the TE terminal will stop listening to all mSAI values. There are several reasons that any terminal can go inactive, which are not related to whether the terminal is a TE terminal or an NTE terminal. Additionally, for TE terminals, some implementations can cause a TE terminal to go inactive whenever the mSAI switch timer expires N times in a row (N is a configurable integer number, such as with a default of 10) without the TE terminal being able to successfully change its mSAI. For example, after N consecutive times of the mSAI switch timer expiring without successful switching, the TE terminal can force itself inactive. If there is still data to send, the TE terminal can immediately attempt to go active again (e.g., using the method of FIG. 19 described above).

In some embodiments, in the case that a TE terminal goes inactive, the IGM can switch the TE terminal's current mSAI and, if applicable, its pending new mSAI, to the pending reuse state 1730 while waiting for the TE terminal to go active again. For example, embodiments can be configured so that successfully switching the mSAI is the responsibility of the TE terminal. Therefore, the IGM does not check problems with completing an mSAI switch. However, if the IGM receives an MSR message instead of an MSCR message from a TE terminal, it can automatically consider the TE terminal to be inactive. The IGM can then engage with making the TE terminal active again according to the received MSR (e.g., using the method of FIG. 20 described above).

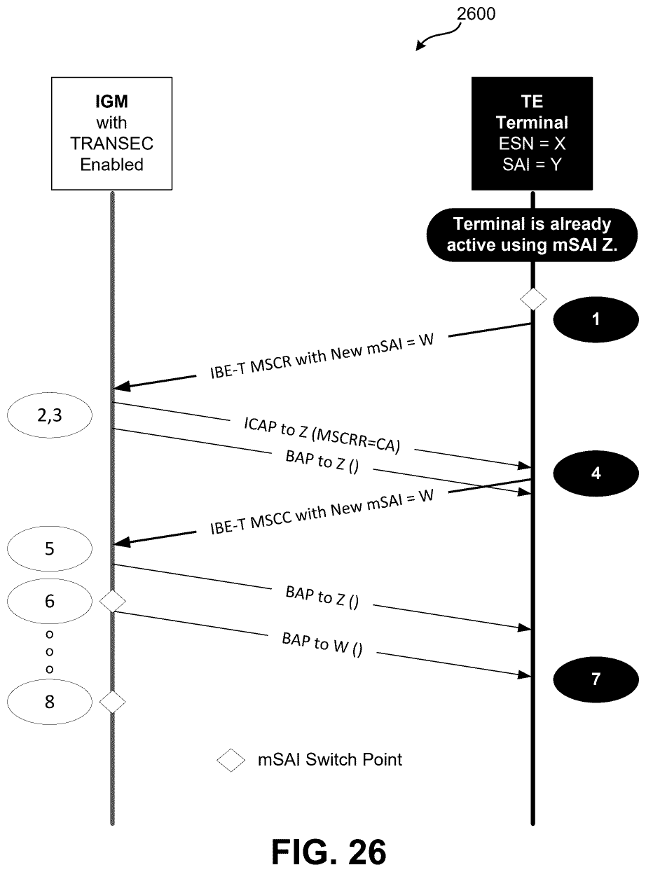

FIG. 26 shows a ladder diagram 2600 representing a TE terminal successfully changing its mSAI while active on a first attempt. The represented scenario assumes a TE terminal is changing its mSAI and its randomly selected new mSAI value does not collide with any existing mSAI values. As noted herein, mSAI collisions are unlikely and should be rare. As such, the scenario represented in FIG. 26 can be assumed as the typical (probable) scenario. The ladder diagram 2600 illustrates message exchanges between an IGM with TRANSEC enabled and a TE terminal. As illustrated, the TE terminal has some ESN represented as ‘X’ and some SAI represented as ‘Y’. Further, as illustrated, the TE Terminal is already active with mSAI ‘Z’ and is running the mSAI switch timer value from the ISDP. Numbers in ovals represent stage numbers (e.g., ‘1’ represents stage 1) of the ladder diagram 2600.

At stage 1, the TE terminal's mSAI switch timeout expires. As such, the TE terminal sends a mSAI Change Request (MSCR) adaptation message to the IGM with a proposed new mSAI (represented as ‘W’).

At stage 2, the IGM checks to see that the requested new mSAI (‘W’) proposed in the MSCR is available. As noted above, the represented scenario assumes the new mSAI is available, and the IGM agrees to the change and responds with ICAP messages addressed to mSAI ‘Z’. The ICAP messages include a mSAI Change Request Received (MSCRR) message with a response code which, in this case, indicates Change Accepted (CA). In stage 3, as described above, the IGM continues to allocate bandwidth to the terminal using mSAI ‘Z’ (the IGM does not immediately switch to using mSAI ‘W’).

In stage 4, the TE terminal receives the ICAP messages with the MSCRR addressed to mSAI ‘Z’. The TE terminal responds with a mSAI Change Confirmed (MSCC) adaptation message and starts listening for bandwidth allocations (and other messages) on mSAI ‘W’ while continuing to listen on mSAI ‘Z’.

At stage 5, when the IGM it receives the MSCC, the IGM enables the mSAI switch for the TE terminal while continuing to allocate bandwidth to the terminal using mSAI ‘Z’. At the next mSAI switch point (represented by a diamond), the IGM switches to using mSAI ‘W’ for the TE terminal and marks mSAI ‘Z’ as being in the pending reuse state 1730.

At stage 7, the TE terminal receives the first message (of any sort) from the IGM addressed to mSAI ‘W’. At that point, it can stop listening to mSAI ‘Z’.

At stage 8, at the next mSAI switch point, the IGM frees up mSAI ‘Z’ for reuse. For example, mSAI ‘Z’ is switched from the pending reuse state 1730 to the available state 1710.

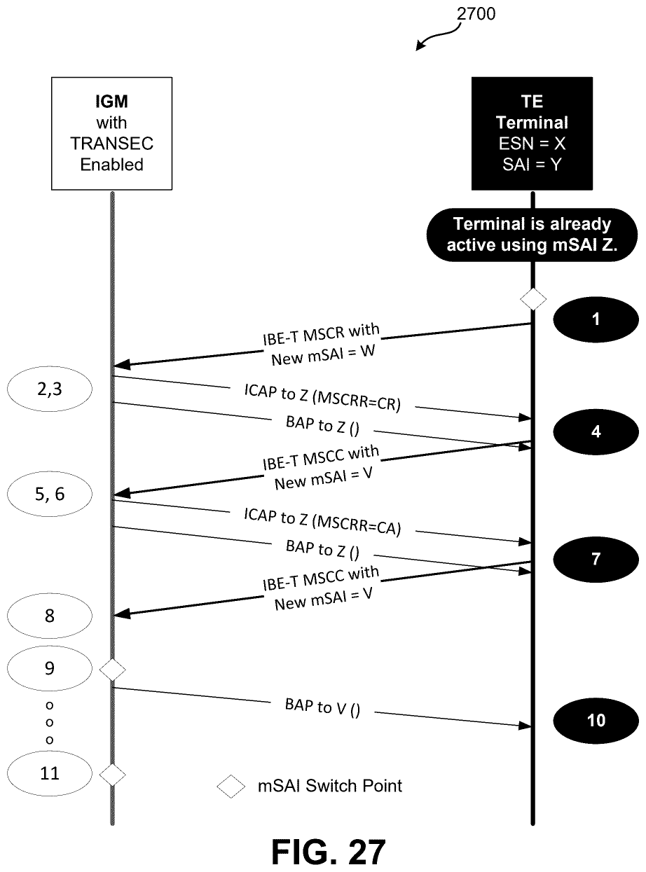

FIG. 27 shows a ladder diagram 2700 representing a TE terminal first unsuccessfully changing its mSAI due to a collision, and then successfully changing its mSAI on a second attempt. As noted herein, mSAI collisions are unlikely and should be rare, but are still possible. The ladder diagram 2700 illustrates message exchanges between an IGM with TRANSEC enabled and a TE terminal. As illustrated, the TE terminal has some ESN represented as ‘X’ and some SAI represented as ‘Y’. Further, as illustrated, the TE Terminal is already active with mSAI ‘Z’ and is running the mSAI switch timer value from the ISDP. Numbers in ovals represent stage numbers (e.g., ‘1’ represents stage 1) of the ladder diagram 2700.

At stage 1, the TE terminal's mSAI switch timeout expires. As such, the TE terminal sends a mSAI Change Request (MSCR) adaptation message to the IGM with a proposed new mSAI (represented as ‘W’).

At stage 2, the IGM checks to see that the requested new mSAI (‘W’) proposed in the MSCR is available. As noted above, the represented scenario assumes the new mSAI is not available. As such, the IGM rejects the change and responds with ICAP messages addressed to mSAI ‘Z’, which includes an MSCRR with a response code that indicates Change Rejected (CR). In stage 3, as described above, the IGM continues to allocate bandwidth to the terminal using mSAI ‘Z’.

In stage 4, the TE terminal receives the ICAP messages with the MSCRR addressed to mSAI ‘Z’. Because its proposed new mSAI was rejected, the TE terminal picks a different new mSAI (represented as ‘V’) and retries.

At stage 5, the IGM checks to see that the requested new mSAI (‘V’) proposed in the MSCR is available. As noted above, the represented scenario assumes the second-proposed new mSAI is available, and the IGM agrees to the change and responds with ICAP messages addressed to mSAI ‘Z’. The ICAP messages include a mSAI Change Request Received (MSCRR) message with a response code which, in this case, indicates Change Accepted (CA). In stage 6, as described above, the IGM continues to allocate bandwidth to the terminal using mSAI ‘Z’ (the IGM does not immediately switch to using mSAI ‘V’).

At stage 7, the TE terminal receives the ICAP messages with the MSCRR addressed to mSAI ‘Z’. The TE terminal responds with a mSAI Change Confirmed (MSCC) adaptation message and starts listening for bandwidth allocations (and other messages) on mSAI ‘V’ while continuing to listen on mSAI ‘Z’.

At stage 8, when the IGM it receives the MSCC, the IGM enables the mSAI switch for the TE terminal while continuing to allocate bandwidth to the terminal using mSAI ‘Z’. In stage 9, at the next mSAI switch point (represented by a diamond), the IGM switches to using mSAI ‘V’ for the TE terminal and marks mSAI ‘Z’ as being in the pending reuse state 1730.

At stage 10, the TE terminal receives the first message (of any sort) from the IGM addressed to mSAI ‘V’. At that point, it can stop listening to mSAI ‘Z’.

At stage 11, at the next mSAI switch point, the IGM frees up mSAI ‘Z’ for reuse. For example, mSAI ‘Z’ is switched from the pending reuse state 1730 to the available state 1710.

The above description includes several different types of ICAP messages used for normal inroute operation, such as EACKs and Inroute Group Change (IGC) messages. The ICAP messages can include additional messages, which tend to be used less frequently. These messages tend to be used only when terminals are active and, thus, will use mSAIs. BAPs are common non-ICAP inroute link-layer messages and include terminal-specific addresses in them. Others (e.g. Multi-Frame BAPs) are sent to active terminals and, therefore, can use mSAIs.

In some embodiments, the features and methods described herein for link-layer address concealment for TE terminals are implemented by computational systems, such as those described with reference to FIGS. 6A and 6B.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for link-layer address concealment for transmission security (TRANSEC) in a satellite communication system, the method comprising:
receiving, by a ground station from a TRANSEC-enabled (TE) terminal, an encrypted unallocated burst including a masked system assigned identifier (mSAI) request (MSR) message identifying a proposed mSAI in association with the TE terminal going active, wherein the proposed mSAI is randomly selected by the TE terminal and is different from a real SAI assigned to the TE terminal;
decrypting the encrypted unallocated burst by the ground station to extract the proposed mSAI;
determining, by the ground station, whether the proposed mSAI is presently in an available state; and
responsive to determining that the proposed mSAI is presently in the available state:
assigning the proposed mSAI to the TE terminal;
transmitting, by the ground station to the TE terminal, a set of inroute command/acknowledgement packet (ICAP) messages comprising an acknowledgement of the encrypted unallocated burst and a terminal identifier (TTID) message; and
allocating bandwidth to the TE terminal using the proposed mSAI.

2. The method of claim 1, further comprising:
receiving an allocated burst, by the ground station from the TE terminal, using the allocated bandwidth; and
transmitting an acknowledgement of the allocated burst, by the ground station to the TE terminal, in response to receiving the allocated burst.

3. The method of claim 2, wherein:
the allocated burst is formatted according to a TRANSEC-supporting inroute burst encapsulation (IBE-T) protocol and has an encrypted portion that is encrypted using a per-terminal electronic serial number (ESN) based session key.

4. The method of claim 1, further comprising:
transmitting, by the ground station to the TE terminal, an inroute set definition packet (ISDP) message indicating that TRANSEC is enabled for an inroute set,
wherein the encrypted unallocated burst is subsequently transmitted by the TE terminal to the ground station using the inroute set after selection of the inroute set by the TE terminal based on the ISDP message.

5. The method of claim 1, wherein:
the encrypted unallocated burst is formatted according to a TRANSEC-supporting inroute burst encapsulation (IBE-T) protocol having an IBE-T header including a TRANSEC information field (TIF) with a nonce and an encrypted portion including the real SAI and the MSR.

6. The method of claim 5, wherein:
the encrypted unallocated burst is encrypted based on a shared inroute session key (ISK); and
the decrypting the encrypted unallocated burst is based on the shared ISK and a crypto counter, the crypto counter constructed by the ground station using the nonce.

7. The method of claim 5, wherein:
the TTID message is generated based on a cryptographic hash of a combination of at least the real SAI and the mSAI.

8. The method of claim 1, further comprising:
discarding the burst and not transmitting the set of ICAP messages responsive to determining that the proposed mSAI is not presently in the available state.

9. A method for link-layer address concealment for transmission security (TRANSEC) in a satellite communication system, the method comprising:
transmitting, by a TRANSEC-enabled (TE) terminal to a ground station, an encrypted unallocated burst including a masked system assigned identifier (mSAI) request (MSR) message identifying a proposed mSAI in association with the TE terminal going active, wherein the proposed mSAI is randomly selected by the TE terminal and is different from a real SAI assigned to the TE terminal;
receiving, by the TE terminal from the ground station, a set of inroute command/acknowledgement packet (ICAP) messages comprising an acknowledgement of the encrypted unallocated burst and a terminal identifier (TTID) message, the TTID message generated by the ground station based at least on the real SAI and the mSAI;
determining, by the TE terminal, that the TTID message indicates that the proposed mSAI has been assigned to the TE terminal by the ground terminal;
listening, by the TE terminal, responsive to determining that the TTID message indicates that the proposed mSAI has been assigned to the TE terminal, for bandwidth allocations from the ground terminal addressed to the proposed mSAI; and
receiving, by the TE terminal during the listening, the bandwidth allocations from the ground station addressed to the proposed mSAI for use in subsequent transmissions of allocated bursts.

10. The method of claim 9, further comprising:
transmitting an allocated burst, by the TE terminal to the ground station, using allocated bandwidth from the bandwidth allocations; and
receiving an acknowledgement of the allocated burst, by the TE terminal from the ground station, in response to transmitting the allocated burst.

11. The method of claim 9, further comprising:
receiving, by the TE terminal, an inroute set definition packet (ISDP) message indicating that TRANSEC is enabled for an inroute set; and
selecting the inroute set for communicating to the ground station in response to receiving the ISDP message,
wherein the encrypted unallocated burst is transmitted using the inroute set.

12. The method of claim 9, wherein:
transmitting the encrypted unallocated burst comprises formatting the encrypted unallocated burst according to a TRANSEC-supporting inroute burst encapsulation (IBE-T) protocol having an IBE-T header including a TRANSEC information field (TIF) with a nonce and an encrypted portion including the real SAI and the MSR, wherein the encrypted portion is encrypted based on a shared inroute session key (ISK).

13. A system for implementing link-layer address concealment in a satellite communication system, the system comprising:
one or more processors; and
a non-transitory, processor-readable memory having instructions stored thereon, which, when executed, cause the one or more processors to perform steps comprising:
receiving, from a TRANSEC-enabled (TE) terminal, an encrypted unallocated burst including a masked system assigned identifier (mSAI) request (MSR) message identifying a proposed mSAI in association with the TE terminal going active, wherein the proposed mSAI is randomly selected by the TE terminal and is different from a real SAI assigned to the TE terminal;
decrypting the encrypted unallocated burst to extract the proposed mSAI;
determining whether the proposed mSAI is presently in an available state; and
responsive to determining that the proposed mSAI is presently in the available state:
assigning the proposed mSAI to the TE terminal;
transmitting, to the TE terminal, a set of inroute command/acknowledgement packet (ICAP) messages comprising an acknowledgement of the encrypted unallocated burst and a terminal identifier (TTID) message; and
allocating bandwidth to the TE terminal using the proposed mSAI.

14. The system of claim 13, wherein the steps further comprise:
receiving an allocated burst, from the TE terminal, using the allocated bandwidth; and
transmitting an acknowledgement of the allocated burst, to the TE terminal, in response to receiving the allocated burst.

15. The system of claim 13, wherein the steps further comprise:
transmitting, to the TE terminal, an inroute set definition packet (ISDP) message indicating that TRANSEC is enabled for an inroute set,
wherein the encrypted unallocated burst is subsequently transmitted by the TE terminal to the ground station using the inroute set after selection of the inroute set by the TE terminal based on the ISDP message.

16. The system of claim 13, wherein:
the encrypted unallocated burst is formatted according to a TRANSEC-supporting inroute burst encapsulation (IBE-T) protocol having an IBE-T header including a TRANSEC information field (TIF) with a nonce and an encrypted portion including the real SAI and the MSR;
the encrypted portion is encrypted based on a shared inroute session key (ISK); and
the decrypting the encrypted unallocated burst is based on the shared ISK.

17. The system of claim 13, wherein the TTID message is generated based on a cryptographic hash of a combination of at least the real SAI and the mSAI.

18. The system of claim 13, wherein the one or more processors is a first one or more processors, the non-transitory, processor-readable memory is a first non-transitory, processor-readable memory, and further comprising:
a second one or more processors disposed in the TE terminal; and
a second non-transitory, processor-readable memory disposed in the TE terminal and having further instructions stored thereon, which, when executed, cause the second one or more processors to perform further steps comprising:
randomly selecting the proposed mSAI;
transmitting the encrypted unallocated burst to the first one or more processors;
receiving, from the first one or more processors, the set of ICAP messages;
determining that the TTID message indicates that the proposed mSAI has been assigned to the TE terminal;
listening, responsive to determining that the TTID message indicates that the proposed mSAI has been assigned to the TE terminal, for bandwidth allocations from the first one or more processors addressed to the proposed mSAI; and
receiving, during the listening, the bandwidth allocations addressed to the proposed mSAI for use in subsequent transmissions of allocated bursts.

19. The system of claim 18, wherein the further steps further comprise:
transmitting an allocated burst using allocated bandwidth from the bandwidth allocations; and
receiving an acknowledgement of the allocated burst in response to transmitting the allocated burst.

20. The system of claim 18, wherein the further steps further comprise:
receiving an inroute set definition packet (ISDP) message indicating that TRANSEC is enabled for an inroute set; and
selecting the inroute set for communicating to the ground station in response to receiving the ISDP message,
wherein the encrypted unallocated burst is transmitted using the inroute set.
